(19) United States
(12) Patent Application Publication
(10) Pub. No.: US 2017/0083339 A1
(43) Pub. Date: Mar. 23, 2017

(54) PREFETCHING ASSOCIATED WITH PREDICATED STORE INSTRUCTIONS

(71) Applicant: Microsoft Technology Licensing, LLC, Redmond, WA (US)

(72) Inventors: Douglas C. Burger, Bellevue, WA (US); Aaron L. Smith, Seattle, WA (US)

(73) Assignee: Microsoft Technology Licensing, LLC, Redmond, WA (US)

(21) Appl. No.: 15/061,408

(22) Filed: Mar. 4, 2016

Related U.S. Application Data
(60) Provisional application No. 62/221,003, filed on Sep. 19, 2015.

(51) Int. Cl. G06F 9/38; G06F 9/30

(52) U.S. Cl. CPC G06F 9/3802; G06F 9/3016

(57) ABSTRACT

Technology related to prefetching data associated with predicated stores of programs in block-based processor architectures is disclosed. In one example of the disclosed technology, a processor includes a block-based processor core for executing an instruction block comprising a plurality of instructions. The block-based processor core includes decode logic and prefetch logic. The decode logic is configured to detect a predicated store instruction of the instruction block. The prefetch logic is configured to calculate a target address of the predicated store instruction and initiate a memory operation associated with the calculated target address before a predicate of the predicated store instruction is calculated.

### CROSS-REFERENCE TO RELATED APPLICATIONS

This application claims the benefit of U.S. Provisional Application No. 62/221,003, entitled “BLOCK-BASED PROCESSORS,” filed Sep. 19, 2015, the entire disclosure of which is incorporated herein by reference in its entirety.

### BACKGROUND

Microprocessors have benefitted from continuing gains in transistor count, integrated circuit cost, manufacturing capital, clock frequency, and energy efficiency due to continued transistor scaling predicted by Moore's law, with little change in associated processor Instruction Set Architectures (ISAs). However, the benefits realized from photolithographic scaling, which drove the semiconductor industry over the last 40 years, are slowing or even reversing. Reduced Instruction Set Computing (RISC) architectures have been the dominant paradigm in processor design for many years. Out-of-order superscalar implementations have not exhibited sustained improvement in area or performance. Accordingly, there is ample opportunity for improvements in processor ISAs to extend performance improvements.

### SUMMARY

Methods, apparatus, and computer-readable storage devices are disclosed for prefetching data associated with predicated load and store instructions of a block-based processor instruction set architecture (BB-ISA). The described techniques and tools can potentially improve processor performance and can be implemented separately, or in various combinations with each other. As will be described more fully below, the described techniques and tools can be implemented in a digital signal processor, microprocessor, application-specific integrated circuit (ASIC), a soft processor (e.g., a microprocessor core implemented in a field programmable gate array (FPGA) using reconfigurable logic), programmable logic, or other suitable logic circuitry. As will be readily apparent to one of ordinary skill in the art, the disclosed technology can be implemented in various computing platforms, including, but not limited to, servers, mainframes, cellphones, smartphones, PDAs, handheld devices, handheld computers, touch screen tablet devices, tablet computers, wearable computers, and laptop computers.

In some examples of the disclosed technology, a processor includes a block-based processor core for executing an instruction block comprising an instruction header and a plurality of instructions. The block-based processor core includes decode logic and prefetch logic. The decode logic is configured to detect a predicated store instruction of the instruction block. The prefetch logic is configured to calculate a target address of the predicated store instruction and initiate a memory operation associated with the calculated target address before a predicate of the predicated store instruction is calculated.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the disclosed subject matter will become more apparent from the following detailed description, which proceeds with reference to the accompanying figures.

### BRIEF DESCRIPTION OF THE DRAWINGS

FIG. 1 illustrates a block-based processor including multiple processor cores, as can be used in some examples of the disclosed technology.

FIG. 2 illustrates a block-based processor core, as can be used in some examples of the disclosed technology.

FIG. 3 illustrates a number of instruction blocks, according to certain examples of disclosed technology.

FIG. 4 illustrates portions of source code and respective instruction blocks.

FIG. 5 illustrates block-based processor headers and instructions, as can be used in some examples of the disclosed technology.

FIG. 6 is a flowchart illustrating an example of a progression of states of a processor core of a block-based processor.

FIG. 7A illustrates an example snippet of source code of a program for a block-based processor.

FIG. 7B illustrates an example of a dependence graph of the example snippet of source code from FIG. 7A.

FIG. 8 illustrates an example instruction block corresponding to the snippet of source code from FIG. 7A, the instruction block comprises predicated load instructions and predicated store instructions.

FIG. 9 is a flowchart illustrating an example method of compiling a program for a block-based processor, as can be performed in some examples of the disclosed technology.

FIG. 10 illustrates an example system for executing an instruction block on a block-based processor core, as can be used in some examples of the disclosed technology.

FIG. 11 illustrates an example system comprising a processor having multiple block-based processor cores and a memory hierarchy, as can be used in some examples of the disclosed technology.

FIGS. 12-13 are flowcharts illustrating example methods of executing an instruction block on a block-based processor core, as can be performed in some examples of the disclosed technology.

FIG. 14 is a block diagram illustrating a suitable computing environment for implementing some embodiments of the disclosed technology.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “emit,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer (e.g., with general-purpose and/or block-based processors executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Disclosed Technologies

Superscalar out-of-order microarchitectures employ substantial circuit resources to rename registers, schedule instructions in dataflow order, clean up after miss-speculation, and retire results in-order for precise exceptions. This includes expensive energy-consuming circuits, such as deep, many-ported register files, many-ported content-accessible memories (CAMs) for dataflow instruction scheduling wakeup, and many-wide bus multiplexers and bypass networks, all of which are resource intensive. For example, FPGA-based implementations of multi-read, multi-write RAMs typically require a mix of replication, multi-cycle operation, clock doubling, bank interleaving, live-value tables, and other expensive techniques.

The disclosed technologies can realize energy efficiency and/or performance enhancement through application of techniques including high instruction-level parallelism (ILP), out-of-order (OoO), superscalar execution, while avoiding substantial complexity and overhead in both processor hardware and associated software. In some examples of the disclosed technology, a block-based processor comprising multiple processor cores uses an Explicit Data Graph Execution (EDGE) ISA designed for area- and energy-efficient, high-ILP execution. In some examples, use of EDGE architectures and associated compilers finesses away much of the register renaming, CAMs, and complexity. In some examples, the respective cores of the block-based processor can store or cache fetched and decoded instructions that may be repeatedly executed, and the fetched and decoded instructions can be reused to potentially achieve reduced power and/or increased performance

In certain examples of the disclosed technology, an EDGE ISA can eliminate the need for one or more complex architectural features, including register renaming, dataflow analysis, misspeculation recovery, and in-order retirement while supporting mainstream programming languages such as C and C++. In certain examples of the disclosed technology, a block-based processor executes a plurality of two or more instructions as an atomic block. Block-based instructions can be used to express semantics of program data flow and/or instruction flow in a more explicit fashion, allowing for improved compiler and processor performance. In certain examples of the disclosed technology, an explicit data graph execution instruction set architecture (EDGE ISA) includes information about program control flow that can be used to improve detection of improper control flow instructions, thereby increasing performance, saving memory resources, and/or and saving energy.

In some examples of the disclosed technology, instructions organized within instruction blocks are fetched, executed, and committed atomically. Intermediate results produced by the instructions within an atomic instruction block are buffered locally until the instruction block is committed. When the instruction block is committed, updates to the visible architectural state resulting from executing the instructions of the instruction block are made visible to other instruction blocks. Instructions inside blocks execute in dataflow order, which reduces or eliminates using register renaming and provides power-efficient OoO execution. A compiler can be used to explicitly encode data dependencies through the ISA, reducing or eliminating burdening processor core control logic from rediscovering dependencies at runtime. Using predicated execution, intra-block branches can be converted to dataflow instructions, and dependencies, other than memory dependencies, can be limited to direct data dependencies. Disclosed target form encoding techniques allow instructions within a block to communicate their operands directly via operand buffers, reducing accesses to a power-hungry, multi-ported physical register files.

Between instruction blocks, instructions can communicate using visible architectural state such as memory and registers. Thus, by utilizing a hybrid dataflow execution model, EDGE architectures can still support imperative programming languages and sequential memory semantics, but desirably also enjoy the benefits of out-of-order execution with near in-order power efficiency and complexity.

In some examples of the disclosed technology, a processor includes a block-based processor core for executing an instruction block comprising an instruction header and a plurality of instructions. The block-based processor core includes decode logic and prefetch logic. The decode logic can be configured to detect a predicated store instruction of the instruction block. The prefetch logic can be configured to calculate a target address of the predicated store instruction and initiate a memory operation associated with the calculated target address before a predicate of the predicated store instruction is calculated. The execution speed of the predicated store instruction can potentially be increased by initiating the memory operation before the predicate of the predicated store instruction is calculated.

As will be readily understood to one of ordinary skill in the relevant art, a spectrum of implementations of the disclosed technology are possible with various area, performance, and power tradeoffs.

### III. Example Block-Based Processor

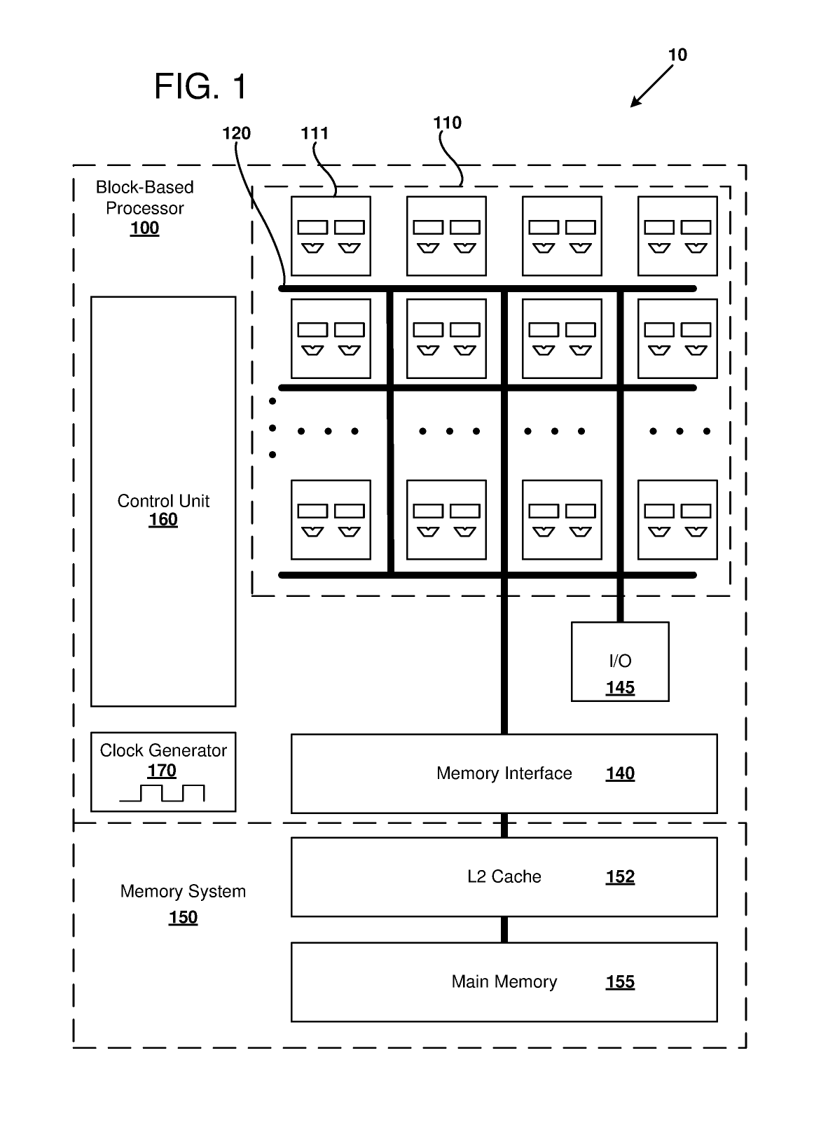

FIG. 1 is a block diagram 10 of a block-based processor 100 as can be implemented in some examples of the disclosed technology. The processor 100 is configured to execute atomic blocks of instructions according to an instruction set architecture (ISA), which describes a number of aspects of processor operation, including a register model, a number of defined operations performed by block-based instructions, a memory model, interrupts, and other architectural features. The block-based processor includes a plurality of processing cores 110, including a processor core 111.

As shown in FIG. 1, the processor cores are connected to each other via core interconnect 120. The core interconnect 120 carries data and control signals between individual ones of the cores 110, a memory interface 140, and an input/output (I/O) interface 145. The core interconnect 120 can transmit and receive signals using electrical, optical, magnetic, or other suitable communication technology and can provide communication connections arranged according to a number of different topologies, depending on a particular desired configuration. For example, the core interconnect 120 can have a crossbar, a bus, a point-to-point bus, or other suitable topology. In some examples, any one of the cores 110 can be connected to any of the other cores, while in other examples, some cores are only connected to a subset of the other cores. For example, each core may only be connected to a nearest 4, 8, or 20 neighboring cores. The core interconnect 120 can be used to transmit input/output data to and from the cores, as well as transmit control signals and other information signals to and from the cores. For example, each of the cores 110 can receive and transmit semaphores that indicate the execution status of instructions currently being executed by each of the respective cores. In some examples, the core interconnect 120 is implemented as wires connecting the cores 110, and memory system, while in other examples, the core interconnect can include circuitry for multiplexing data signals on the interconnect wire(s), switch and/or routing components, including active signal drivers and repeaters, or other suitable circuitry. In some examples of the disclosed technology, signals transmitted within and to/from the processor 100 are not limited to full swing electrical digital signals, but the processor can be configured to include differential signals, pulsed signals, or other suitable signals for transmitting data and control signals.

In the example of FIG. 1, the memory interface 140 of the processor includes interface logic that is used to connect to additional memory, for example, memory located on another integrated circuit besides the processor 100. As shown in FIG. 1 an external memory system 150 includes an L2 cache 152 and main memory 155. In some examples the L2 cache can be implemented using static RAM (SRAM) and the main memory 155 can be implemented using dynamic RAM (DRAM). In some examples the memory system 150 is included on the same integrated circuit as the other components of the processor 100. In some examples, the memory interface 140 includes a direct memory access (DMA) controller allowing transfer of blocks of data in memory without using register file(s) and/or the processor 100. In some examples, the memory interface 140 can include a memory management unit (MMU) for managing and allocating virtual memory, expanding the available main memory 155.

The I/O interface 145 includes circuitry for receiving and sending input and output signals to other components, such as hardware interrupts, system control signals, peripheral interfaces, co-processor control and/or data signals (e.g., signals for a graphics processing unit, floating point coprocessor, physics processing unit, digital signal processor, or other co-processing components), clock signals, semaphores, or other suitable I/O signals. The I/O signals may be synchronous or asynchronous. In some examples, all or a portion of the I/O interface is implemented using memory-mapped I/O techniques in conjunction with the memory interface 140.

The block-based processor 100 can also include a control unit 160. The control unit can communicate with the processing cores 110, the I/O interface 145, and the memory interface 140 via the core interconnect 120 or a side-band interconnect (not shown). The control unit 160 supervises operation of the processor 100. Operations that can be performed by the control unit 160 can include allocation and de-allocation of cores for performing instruction processing, control of input data and output data between any of the cores, register files, the memory interface 140, and/or the I/O interface 145, modification of execution flow, and verifying target location(s) of branch instructions, instruction headers, and other changes in control flow. The control unit 160 can also process hardware interrupts, and control reading and writing of special system registers, for example the program counter stored in one or more register file(s). In some examples of the disclosed technology, the control unit 160 is at least partially implemented using one or more of the processing cores 110, while in other examples, the control unit 160 is implemented using a non-block-based processing core (e.g., a general-purpose RISC processing core coupled to memory). In some examples, the control unit 160 is implemented at least in part using one or more of: hardwired finite state machines, programmable microcode, programmable gate arrays, or other suitable control circuits. In alternative examples, control unit functionality can be performed by one or more of the cores 110.

The control unit 160 includes a scheduler that is used to allocate instruction blocks to the processor cores 110. As used herein, scheduler allocation refers to hardware for directing operation of instruction blocks, including initiating instruction block mapping, fetching, decoding, execution, committing, aborting, idling, and refreshing an instruction block. In some examples, the hardware receives signals generated using computer-executable instructions to direct operation of the instruction scheduler. Processor cores 110 are assigned to instruction blocks during instruction block mapping. The recited stages of instruction operation are for illustrative purposes, and in some examples of the disclosed technology, certain operations can be combined, omitted, separated into multiple operations, or additional operations added.

The block-based processor 100 also includes a clock generator 170, which distributes one or more clock signals to various components within the processor (e.g., the cores 110, interconnect 120, memory interface 140, and I/O interface 145). In some examples of the disclosed technology, all of the components share a common clock, while in other examples different components use a different clock, for example, a clock signal having differing clock frequencies. In some examples, a portion of the clock is gated to allow power savings when some of the processor components are not in use. In some examples, the clock signals are generated using a phase-locked loop (PLL) to generate a signal of fixed, constant frequency and duty cycle. Circuitry that receives the clock signals can be triggered on a single edge (e.g., a rising edge) while in other examples, at least some of the receiving circuitry is triggered by rising and falling clock edges. In some examples, the clock signal can be transmitted optically or wirelessly.

### IV. Example Block-Based Processor Core

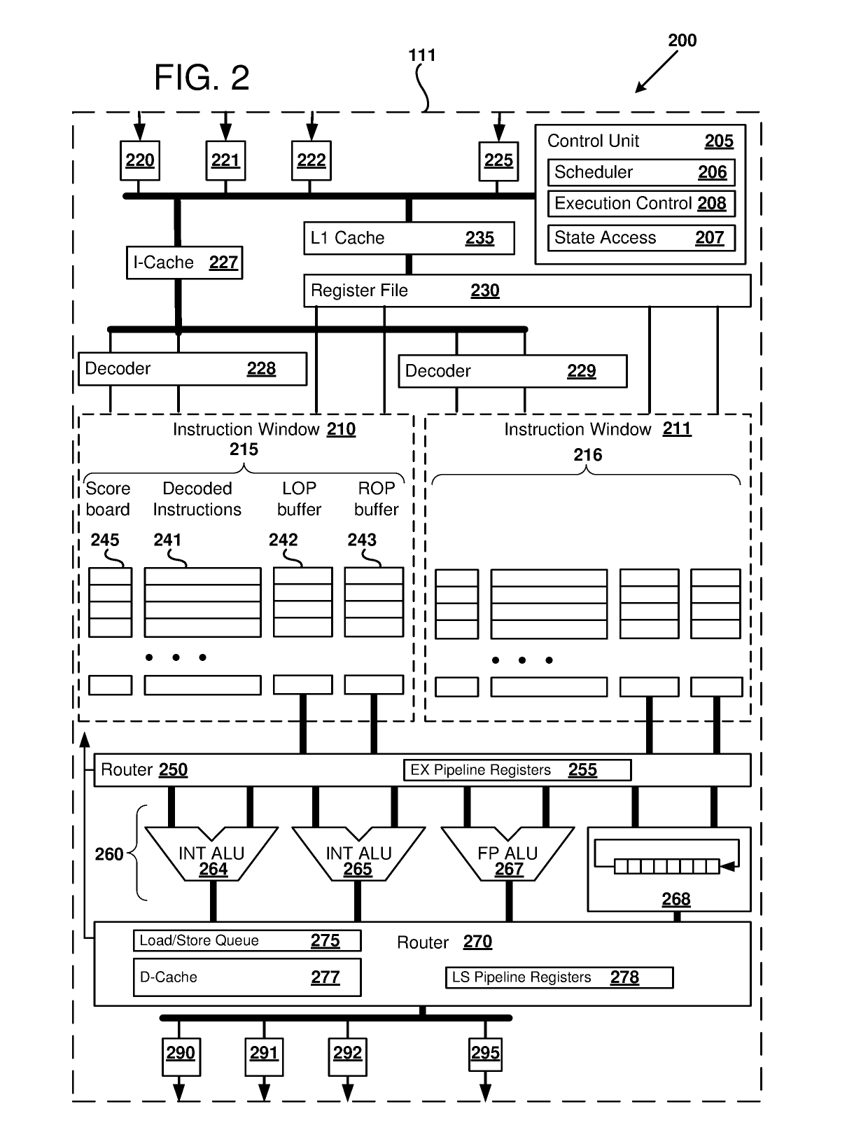

FIG. 2 is a block diagram 200 further detailing an example microarchitecture for the block-based processor 100, and in particular, an instance of one of the block-based processor cores (processor core 111), as can be used in certain examples of the disclosed technology. For ease of explanation, the exemplary block-based processor core 111 is illustrated with five stages: instruction fetch (IF), decode (DC), operand fetch, execute (EX), and memory/data access (LS). However, it will be readily understood by one of ordinary skill in the relevant art that modifications to the illustrated microarchitecture, such as adding/removing stages, adding/removing units that perform operations, and other implementation details can be modified to suit a particular application for a block-based processor.

In some examples of the disclosed technology, the processor core 111 can be used to execute and commit an instruction block of a program. An instruction block is an atomic collection of block-based-processor instructions that includes an instruction block header and a plurality of instructions. As will be discussed further below, the instruction block header can include information describing an execution mode of the instruction block and information that can be used to further define semantics of one or more of the plurality of instructions within the instruction block. Depending on the particular ISA and processor hardware used, the instruction block header can also be used, during execution of the instructions, to improve performance of executing an instruction block by, for example, allowing for early fetching of instructions and/or data, improved branch prediction, speculative execution, improved energy efficiency, and improved code compactness.

The instructions of the instruction block can be dataflow instructions that explicitly encode relationships between producer-consumer instructions of the instruction block. In particular, an instruction can communicate a result directly to a targeted instruction through an operand buffer that is reserved only for the targeted instruction. The intermediate results stored in the operand buffers are generally not visible to cores outside of the executing core because the block-atomic execution model only passes final results between the instruction blocks. The final results from executing the instructions of the atomic instruction block are made visible outside of the executing core when the instruction block is committed. Thus, the visible architectural state generated by each instruction block can appear as a single transaction outside of the executing core, and the intermediate results are typically not observable outside of the executing core.

As shown in FIG. 2, the processor core 111 includes a control unit 205, which can receive control signals from other cores and generate control signals to regulate core operation and schedules the flow of instructions within the core using an instruction scheduler 206. The control unit 205 can include state access logic 207 for examining core status and/or configuring operating modes of the processor core 111. The control unit 205 can include execution control logic 208 for generating control signals during one or more operating modes of the processor core 111. Operations that can be performed by the control unit 205 and/or instruction scheduler 206 can include allocation and de-allocation of cores for performing instruction processing, control of input data and output data between any of the cores, register files, the memory interface 140, and/or the I/O interface 145. The control unit 205 can also process hardware interrupts, and control reading and writing of special system registers, for example the program counter stored in one or more register file(s). In other examples of the disclosed technology, the control unit 205 and/or instruction scheduler 206 are implemented using a non-block-based processing core (e.g., a general-purpose RISC processing core coupled to memory). In some examples, the control unit 205, instruction scheduler 206, state access logic 207, and/or execution control logic 208 are implemented at least in part using one or more of: hardwired finite state machines, programmable microcode, programmable gate arrays, or other suitable control circuits.

The control unit 205 can decode the instruction block header to obtain information about the instruction block. For example, execution modes of the instruction block can be specified in the instruction block header though various execution flags. The decoded execution mode can be stored in registers of the execution control logic 208. Based on the execution mode, the execution control logic 208 can generate control signals to regulate core operation and schedule the flow of instructions within the core 111, such as by using the instruction scheduler 206. For example, during a default execution mode, the execution control logic 208 can sequence the instructions of one or more instruction blocks executing on one or more instruction windows (e.g., 210, 211) of the processor core 111. Specifically, each of the instructions can be sequenced through the instruction fetch, decode, operand fetch, execute, and memory/data access stages so that the instructions of an instruction block can be pipelined and executed in parallel. The instructions are ready to execute when their operands are available, and the instruction scheduler 206 can select the order in which to execute the instructions. As another example, the execution control logic 208 can include prefetch logic for fetching data associated with load and store instructions before the load and store instructions are executed.

The state access logic 207 can include an interface for other cores and/or a processor-level control unit (such as the control unit 160 of FIG. 1) to communicate with and access state of the core 111. For example, the state access logic 207 can be connected to a core interconnect (such as the core interconnect 120 of FIG. 1) and the other cores can communicate via control signals, messages, reading and writing registers, and the like.

The state access logic 207 can include control state registers or other logic for modifying and/or examining modes and/or status of an instruction block and/or core status. As an example, the core status can indicate whether an instruction block is mapped to the core 111 or an instruction window (e.g., instruction windows 210, 211) of the core 111, whether an instruction block is resident on the core 111, whether an instruction block is executing on the core 111, whether the instruction block is ready to commit, whether the instruction block is performing a commit, and whether the instruction block is idle. As another example, the status of an instruction block can include a token or flag indicating the instruction block is the oldest instruction block executing and a flag indicating the instruction block is executing speculatively.

The control state registers (CSRs) can be mapped to unique memory locations that are reserved for use by the block-based processor. For example, CSRs of the control unit 160 (FIG. 1) can be assigned to a first range of addresses, CSRs of the memory interface 140 (FIG. 1) can be assigned to a second range of addresses, a first processor core can be assigned to a third range of addresses, a second processor core can be assigned to a fourth range of addresses, and so forth. In one embodiment, the CSRs can be accessed using general purpose memory read and write instructions of the block-based processor. Additionally or alternatively, the CSRs can be accessed using specific read and write instructions (e.g., the instructions have opcodes different from the memory read and write instructions) for the CSRs. Thus, one core can examine the configuration state of a different core by reading from an address corresponding to the different core's CSRs. Similarly, one core can modify the configuration state of a different core by writing to an address corresponding to the different core's CSRs. Additionally or alternatively, the CSRs can be accessed by shifting commands into the state access logic 207 through serial scan chains. In this manner, one core can examine the state access logic 207 of a different core and one core can modify the state access logic 207 or modes of a different core.

Each of the instruction windows 210 and 211 can receive instructions and data from one or more of input ports 220, 221, and 222 which connect to an interconnect bus and instruction cache 227, which in turn is connected to the instruction decoders 228 and 229. Additional control signals can also be received on an additional input port 225. Each of the instruction decoders 228 and 229 decodes instructions for an instruction block and stores the decoded instructions within a memory store 215 and 216 located in each respective instruction window 210 and 211.

The processor core 111 further includes a register file 230 coupled to an L1 (level one) cache 235. The register file 230 stores data for registers defined in the block-based processor architecture, and can have one or more read ports and one or more write ports. For example, a register file may include two or more write ports for storing data in the register file, as well as having a plurality of read ports for reading data from individual registers within the register file. In some examples, a single instruction window (e.g., instruction window 210) can access only one port of the register file at a time, while in other examples, the instruction window 210 can access one read port and one write port, or can access two or more read ports and/or write ports simultaneously. In some examples, the register file 230 can include 64 registers, each of the registers holding a word of 32 bits of data. (This application will refer to 32-bits of data as a word, unless otherwise specified.) In some examples, some of the registers within the register file 230 may be allocated to special purposes. For example, some of the registers can be dedicated as system registers examples of which include registers storing constant values (e.g., an all zero word), program counter(s) (PC), which indicate the current address of a program thread that is being executed, a physical core number, a logical core number, a core assignment topology, core control flags, a processor topology, or other suitable dedicated purpose. In some examples, there are multiple program counter registers, one or each program counter, to allow for concurrent execution of multiple execution threads across one or more processor cores and/or processors. In some examples, program counters are implemented as designated memory locations instead of as registers in a register file. In some examples, use of the system registers may be restricted by the operating system or other supervisory computer instructions. In some examples, the register file 230 is implemented as an array of flip-flops, while in other examples, the register file can be implemented using latches, SRAM, or other forms of memory storage. The ISA specification for a given processor, for example processor 100, specifies how registers within the register file 230 are defined and used.

In some examples, the processor 100 includes a global register file that is shared by a plurality of the processor cores. In some examples, individual register files associated with a processor core can be combined to form a larger file, statically or dynamically, depending on the processor ISA and configuration.

As shown in FIG. 2, the memory store 215 of the instruction window 210 includes a number of decoded instructions 241, a left operand (LOP) buffer 242, a right operand (ROP) buffer 243, and an instruction scoreboard 245. In some examples of the disclosed technology, each instruction of the instruction block is decomposed into a row of decoded instructions, left and right operands, and scoreboard data, as shown in FIG. 2. The decoded instructions 241 can include partially- or fully-decoded versions of instructions stored as bit-level control signals. The operand buffers 242 and 243 store operands (e.g., register values received from the register file 230, data received from memory, immediate operands coded within an instruction, operands calculated by an earlier-issued instruction, or other operand values) until their respective decoded instructions are ready to execute. Instruction operands are read from the operand buffers 242 and 243, not the register file.

The memory store 216 of the second instruction window 211 stores similar instruction information (decoded instructions, operands, and scoreboard) as the memory store 215, but is not shown in FIG. 2 for the sake of simplicity. Instruction blocks can be executed by the second instruction window 211 concurrently or sequentially with respect to the first instruction window, subject to ISA constraints and as directed by the control unit 205.

In some examples of the disclosed technology, front-end pipeline stages IF and DC can run decoupled from the back-end pipelines stages (IS, EX, LS). In one embodiment, the control unit can fetch and decode two instructions per clock cycle into each of the instruction windows 210 and 211. In alternative embodiments, the control unit can fetch and decode one, four, or another number of instructions per clock cycle into a corresponding number of instruction windows. The control unit 205 provides instruction window dataflow scheduling logic to monitor the ready state of each decoded instruction's inputs (e.g., each respective instruction's predicate(s) and operand(s) using the scoreboard 245. When all of the inputs for a particular decoded instruction are ready, the instruction is ready to issue. The control logic 205 then initiates execution of one or more next instruction(s) (e.g., the lowest numbered ready instruction) each cycle and its decoded instruction and input operands are sent to one or more of functional units 260 for execution. The decoded instruction can also encode a number of ready events. The scheduler in the control logic 205 accepts these and/or events from other sources and updates the ready state of other instructions in the window. Thus execution proceeds, starting with the processor core's 111 ready zero input instructions, instructions that are targeted by the zero input instructions, and so forth.

The decoded instructions 241 need not execute in the same order in which they are arranged within the memory store 215 of the instruction window 210. Rather, the instruction scoreboard 245 is used to track dependencies of the decoded instructions and, when the dependencies have been met, the associated individual decoded instruction is scheduled for execution. For example, a reference to a respective instruction can be pushed onto a ready queue when the dependencies have been met for the respective instruction, and instructions can be scheduled in a first-in first-out (FIFO) order from the ready queue. Information stored in the scoreboard 245 can include, but is not limited to, the associated instruction's execution predicate (such as whether the instruction is waiting for a predicate bit to be calculated and whether the instruction executes if the predicate bit is true or false), availability of operands to the instruction, or other prerequisites required before executing the associated individual instruction.

In one embodiment, the scoreboard 245 can include decoded ready state, which is initialized by the instruction decoder 228, and active ready state, which is initialized by the control unit 205 during execution of the instructions. For example, the decoded ready state can encode whether a respective instruction has been decoded, awaits a predicate and/or some operand(s), perhaps via a broadcast channel, or is immediately ready to issue. The active ready state can encode whether a respective instruction awaits a predicate and/or some operand(s), is ready to issue, or has already issued. The decoded ready state can cleared on a block reset or a block refresh. Upon branching to a new instruction block, the decoded ready state and the active ready state is cleared (a block or core reset). However, when an instruction block is re-executed on the core, such as when it branches back to itself (a block refresh), only active ready state is cleared. Block refreshes can occur immediately (when an instruction block branches to itself) or after executing a number of other intervening instruction blocks. The decoded ready state for the instruction block can thus be preserved so that it is not necessary to re-fetch and decode the block's instructions. Hence, block refresh can be used to save time and energy in loops and other repeating program structures.

The number of instructions that are stored in each instruction window generally corresponds to the number of instructions within an instruction block. In some examples, the number of instructions within an instruction block can be 32, 64, 128, 1024, or another number of instructions. In some examples of the disclosed technology, an instruction block is allocated across multiple instruction windows within a processor core. In some examples, the instruction windows 210, 211 can be logically partitioned so that multiple instruction blocks can be executed on a single processor core. For example, one, two, four, or another number of instruction blocks can be executed on one core. The respective instruction blocks can be executed concurrently or sequentially with each other.

Instructions can be allocated and scheduled using the control unit 205 located within the processor core 111. The control unit 205 orchestrates fetching of instructions from memory, decoding of the instructions, execution of instructions once they have been loaded into a respective instruction window, data flow into/out of the processor core 111, and control signals input and output by the processor core. For example, the control unit 205 can include the ready queue, as described above, for use in scheduling instructions. The instructions stored in the memory store 215 and 216 located in each respective instruction window 210 and 211 can be executed atomically. Thus, updates to the visible architectural state (such as the register file 230 and the memory) affected by the executed instructions can be buffered locally within the core until the instructions are committed. The control unit 205 can determine when instructions are ready to be committed, sequence the commit logic, and issue a commit signal. For example, a commit phase for an instruction block can begin when all register writes are buffered, all writes to memory are buffered, and a branch target is calculated. The instruction block can be committed when updates to the visible architectural state are complete. For example, an instruction block can be committed when the register writes are written to the register file, the stores are sent to a load/store unit or memory controller, and the commit signal is generated. The control unit 205 also controls, at least in part, allocation of functional units 260 to each of the respective instructions windows.

As shown in FIG. 2, a first router 250, which has a number of execution pipeline registers 255, is used to send data from either of the instruction windows 210 and 211 to one or more of the functional units 260, which can include but are not limited to, integer ALUs (arithmetic logic units) (e.g., integer ALUs 264 and 265), floating point units (e.g., floating point ALU 267), shift/rotate logic (e.g., barrel shifter 268), or other suitable execution units, which can including graphics functions, physics functions, and other mathematical operations. Data from the functional units 260 can then be routed through a second router 270 to outputs 290, 291, and 292, routed back to an operand buffer (e.g. LOP buffer 242 and/or ROP buffer 243), or fed back to another functional unit, depending on the requirements of the particular instruction being executed. The second router 270 can include a load/store queue 275, which can be used to issue memory instructions, a data cache 277, which stores data being output from the core to memory, and load/store pipeline register 278.

The core also includes control outputs 295 which are used to indicate, for example, when execution of all of the instructions for one or more of the instruction windows 210 or 211 has completed. When execution of an instruction block is complete, the instruction block is designated as “committed” and signals from the control outputs 295 can in turn can be used by other cores within the block-based processor 100 and/or by the control unit 160 to initiate scheduling, fetching, and execution of other instruction blocks. Both the first router 250 and the second router 270 can send data back to the instruction (for example, as operands for other instructions within an instruction block).

As will be readily understood to one of ordinary skill in the relevant art, the components within an individual core are not limited to those shown in FIG. 2, but can be varied according to the requirements of a particular application. For example, a core may have fewer or more instruction windows, a single instruction decoder might be shared by two or more instruction windows, and the number of and type of functional units used can be varied, depending on the particular targeted application for the block-based processor. Other considerations that apply in selecting and allocating resources with an instruction core include performance requirements, energy usage requirements, integrated circuit die, process technology, and/or cost.

It will be readily apparent to one of ordinary skill in the relevant art that trade-offs can be made in processor performance by the design and allocation of resources within the instruction window (e.g., instruction window 210) and control logic 205 of the processor cores 110. The area, clock period, capabilities, and limitations substantially determine the realized performance of the individual cores 110 and the throughput of the block-based processor cores 110.

The instruction scheduler 206 can have diverse functionality. In certain higher performance examples, the instruction scheduler is highly concurrent. For example, each cycle, the decoder(s) write instructions' decoded ready state and decoded instructions into one or more instruction windows, selects the next instruction to issue, and, in response the back end sends ready events—either target-ready events targeting a specific instruction's input slot (predicate, left operand, right operand, etc.), or broadcast-ready events targeting all instructions. The per-instruction ready state bits, together with the decoded ready state can be used to determine that the instruction is ready to issue.

In some examples, the instruction scheduler 206 is implemented using storage (e.g., first-in first-out (FIFO) queues, content addressable memories (CAMs)) storing data indicating information used to schedule execution of instruction blocks according to the disclosed technology. For example, data regarding instruction dependencies, transfers of control, speculation, branch prediction, and/or data loads and stores are arranged in storage to facilitate determinations in mapping instruction blocks to processor cores. For example, instruction block dependencies can be associated with a tag that is stored in a FIFO or CAM and later accessed by selection logic used to map instruction blocks to one or more processor cores. In some examples, the instruction scheduler 206 is implemented using a general purpose processor coupled to memory, the memory being configured to store data for scheduling instruction blocks. In some examples, instruction scheduler 206 is implemented using a special purpose processor or using a block-based processor core coupled to the memory. In some examples, the instruction scheduler 206 is implemented as a finite state machine coupled to the memory. In some examples, an operating system executing on a processor (e.g., a general purpose processor or a block-based processor core) generates priorities, predictions, and other data that can be used at least in part to schedule instruction blocks with the instruction scheduler 206. As will be readily apparent to one of ordinary skill in the relevant art, other circuit structures, implemented in an integrated circuit, programmable logic, or other suitable logic can be used to implement hardware for the instruction scheduler 206.

In some cases, the scheduler 206 accepts events for target instructions that have not yet been decoded and must also inhibit reissue of issued ready instructions. Instructions can be non-predicated, or predicated (based on a true or false condition). A predicated instruction does not become ready until it is targeted by another instruction's predicate result, and that result matches the predicate condition. If the associated predicate does not match, the instruction never issues. In some examples, predicated instructions may be issued and executed speculatively. In some examples, a processor may subsequently check that speculatively issued and executed instructions were correctly speculated. In some examples a misspeculated issued instruction and the specific transitive closure of instructions in the block that consume its outputs may be re-executed, or misspeculated side effects annulled. In some examples, discovery of a misspeculated instruction leads to the complete roll back and re-execution of an entire block of instructions.

### V. Example Stream of Instruction Blocks

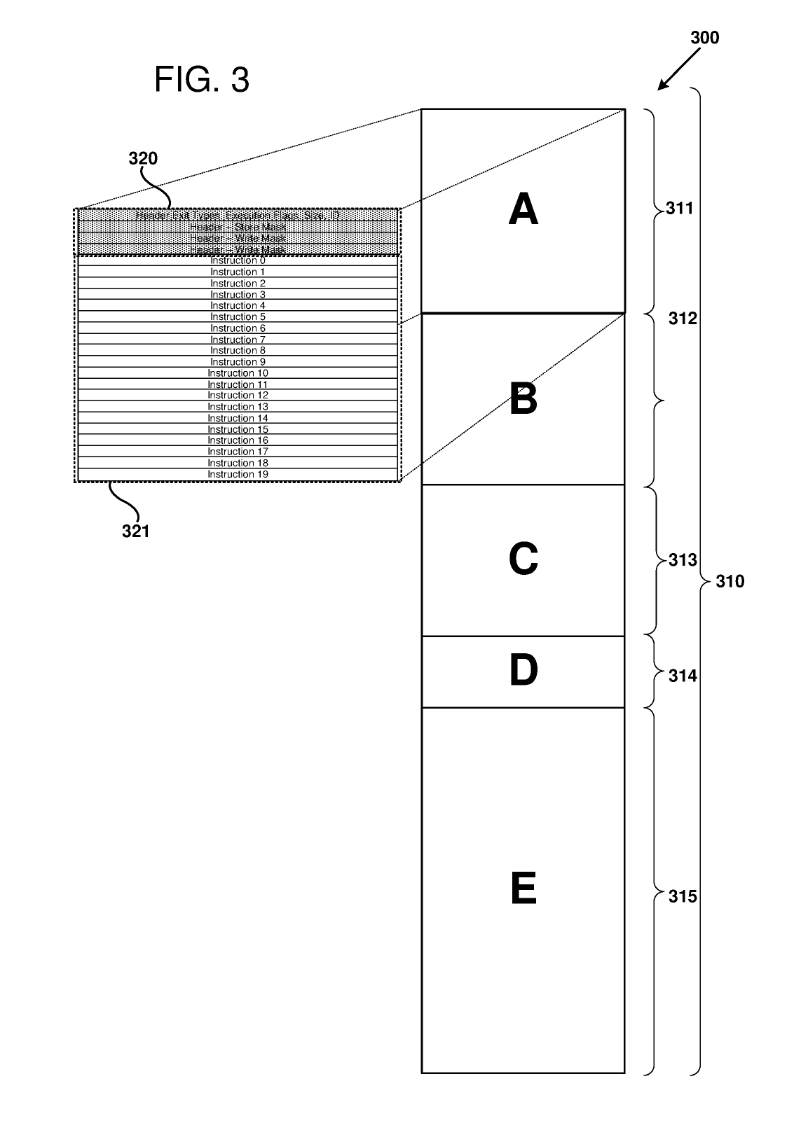

Turning now to the diagram 300 of FIG. 3, a portion 310 of a stream of block-based instructions, including a number of variable length instruction blocks 311-315 (A-E) is illustrated. The stream of instructions can be used to implement user application, system services, or any other suitable use. In the example shown in FIG. 3, each instruction block begins with an instruction header, which is followed by a varying number of instructions. For example, the instruction block 311 includes a header 320 and twenty instructions 321. The particular instruction header 320 illustrated includes a number of data fields that control, in part, execution of the instructions within the instruction block, and also allow for improved performance enhancement techniques including, for example branch prediction, speculative execution, lazy evaluation, and/or other techniques. The instruction header 320 also includes an ID bit which indicates that the header is an instruction header and not an instruction. The instruction header 320 also includes an indication of the instruction block size. The instruction block size can be in larger chunks of instructions than one, for example, the number of 4-instruction chunks contained within the instruction block. In other words, the size of the block is shifted 4 bits in order to compress header space allocated to specifying instruction block size. Thus, a size value of 0 indicates a minimally-sized instruction block which is a block header followed by four instructions. In some examples, the instruction block size is expressed as a number of bytes, as a number of words, as a number of n-word chunks, as an address, as an address offset, or using other suitable expressions for describing the size of instruction blocks. In some examples, the instruction block size is indicated by a terminating bit pattern in the instruction block header and/or footer.

The instruction block header 320 can also include execution flags, which indicate special instruction execution requirements. For example, branch prediction or memory dependence prediction can be inhibited for certain instruction blocks, depending on the particular application. As another example, an execution flag can be used to control whether prefetching is enabled for data and/or instructions of certain instruction blocks.

In some examples of the disclosed technology, the instruction header 320 includes one or more identification bits that indicate that the encoded data is an instruction header. For example, in some block-based processor ISAs, a single ID bit in the least significant bit space is always set to the binary value 1 to indicate the beginning of a valid instruction block. In other examples, different bit encodings can be used for the identification bit(s). In some examples, the instruction header 320 includes information indicating a particular version of the ISA for which the associated instruction block is encoded.

The block instruction header can also include a number of block exit types for use in, for example, branch prediction, control flow determination, and/or bad jump detection. The exit type can indicate what the type of branch instructions are, for example: sequential branch instructions, which point to the next contiguous instruction block in memory; offset instructions, which are branches to another instruction block at a memory address calculated relative to an offset; subroutine calls, or subroutine returns. By encoding the branch exit types in the instruction header, the branch predictor can begin operation, at least partially, before branch instructions within the same instruction block have been fetched and/or decoded.

The instruction block header 320 also includes a store mask which identifies the load-store queue identifiers that are assigned to store operations. The instruction block header can also include a write mask, which identifies which global register(s) the associated instruction block will write. The associated register file must receive a write to each entry before the instruction block can complete. In some examples a block-based processor architecture can include not only scalar instructions, but also single-instruction multiple-data (SIMD) instructions, that allow for operations with a larger number of data operands within a single instruction.

### VI. Example Block Instruction Target Encoding

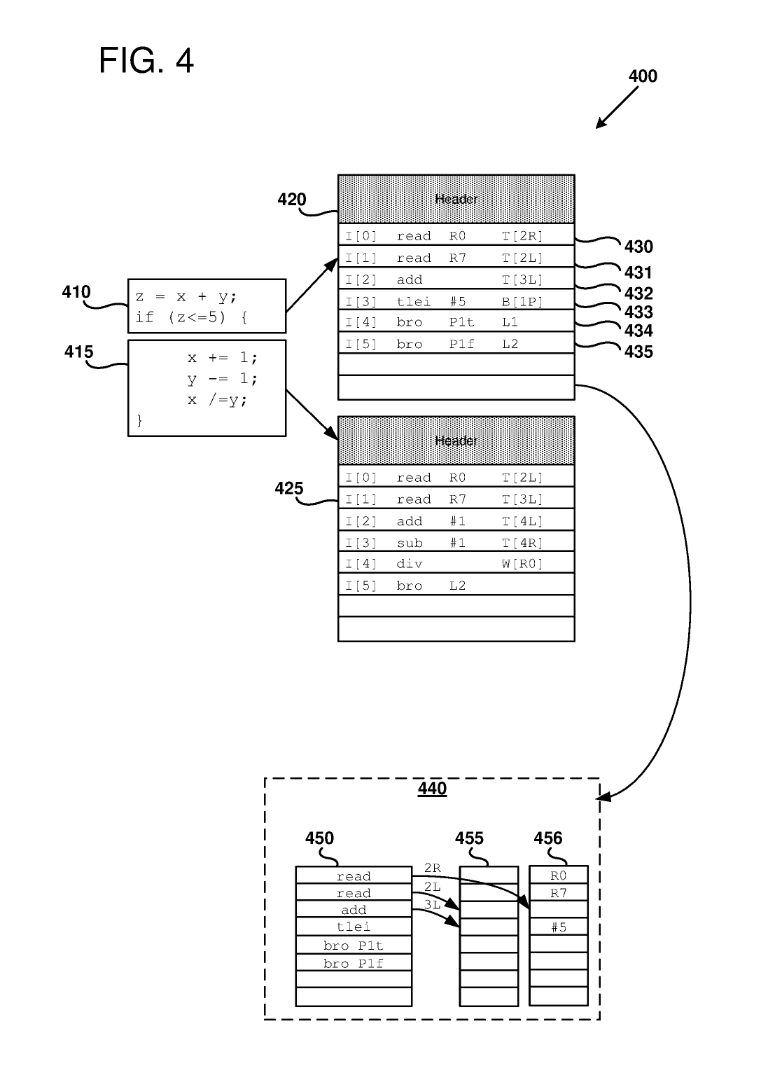

FIG. 4 is a diagram 400 depicting an example of two portions 410 and 415 of C language source code and their respective instruction blocks 420 and 425 (in assembly language), illustrating how block-based instructions can explicitly encode their targets. The high-level C language source code can be translated to the low-level assembly language and machine code by a compiler whose target is a block-based processor. A high-level language can abstract out many of the details of the underlying computer architecture so that a programmer can focus on functionality of the program. In contrast, the machine code encodes the program according to the target computer's ISA so that it can be executed on the target computer, using the computer's hardware resources. Assembly language is a human-readable form of machine code.

In the following examples, the assembly language instructions use the following nomenclature: “I[<number>] specifies the number of the instruction within the instruction block where the numbering begins at zero for the instruction following the instruction header and the instruction number is incremented for each successive instruction; the operation of the instruction (such as READ, ADDI, DIV, and the like) follows the instruction number; optional values (such as the immediate value 1) or references to registers (such as R0 for register 0) follow the operation; and optional targets that are to receive the results of the instruction follow the values and/or operation. Each of the targets can be to another instruction, a broadcast channel to other instructions, or a register that can be visible to another instruction block when the instruction block is committed. An example of an instruction target is T[1R] which targets the right operand of instruction 1. An example of a register target is W[R0], where the target is written to register 0.

In the diagram 400, the first two READ instructions 430 and 431 of the instruction block 420 target the right (T[2R]) and left (T[2L]) operands, respectively, of the ADD instruction 432. In the illustrated ISA, the read instruction is the only instruction that reads from the global register file; however any instruction can target, the global register file. When the ADD instruction 432 receives the result of both register reads it will become ready and execute.

When the TLEI (test-less-than-equal-immediate) instruction 433 receives its single input operand from the ADD, it will become ready and execute. The test then produces a predicate operand that is broadcast on channel one (B[1P]) to all instructions listening on the broadcast channel, which in this example are the two predicated branch instructions (BRO P1t 434 and BRO P1f 435). In the assembly language of the diagram 400, “P1f” indicates the instruction is predicated (the “P”) on a false result (the “f”) being transmitted on broadcast channel 1 (the “1”), and “P1t” indicates the instruction is predicated on a true result being transmitted on broadcast channel 1. The branch that receives a matching predicate will fire.

A dependence graph 440 for the instruction block 420 is also illustrated, as an array 450 of instruction nodes and their corresponding operand targets 455 and 456. This illustrates the correspondence between the block instructions 420, the corresponding instruction window entries, and the underlying dataflow graph represented by the instructions. Here decoded instructions READ 430 and READ 431 are ready to issue, as they have no input dependencies. As they issue and execute, the values read from registers R6 and R7 are written into the right and left operand buffers of ADD 432, marking the left and right operands of ADD 432 “ready.” As a result, the ADD 432 instruction becomes ready, issues to an ALU, executes, and the sum is written to the left operand of TLEI 433.

As a comparison, a conventional out-of-order RISC or CISC processor would dynamically build the dependence graph at runtime, using additional hardware complexity, power, area and reducing clock frequency and performance. However, the dependence graph is known statically at compile time and an EDGE compiler can directly encode the producer-consumer relations between the instructions through the ISA, freeing the microarchitecture from rediscovering them dynamically. This can potentially enable a simpler microarchitecture, reducing area, power and boosting frequency and performance.

### VII. Example Block-Based Instruction Formats

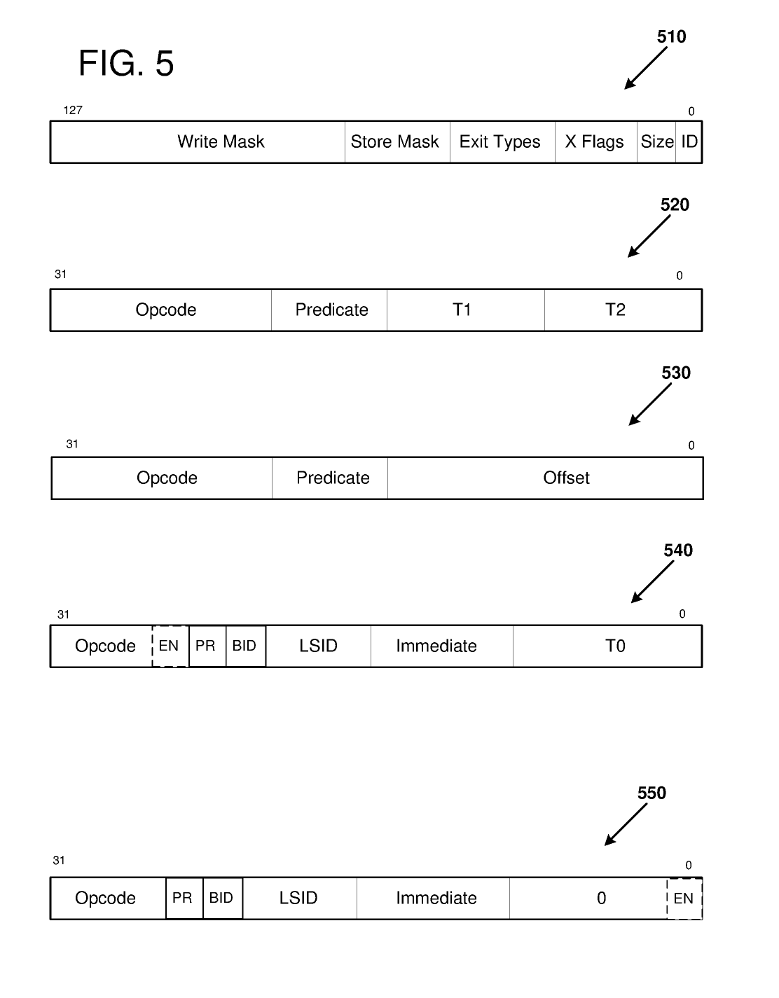

FIG. 5 is a diagram illustrating generalized examples of instruction formats for an instruction header 510, a generic instruction 520, a branch instruction 530, a load instruction 540, and a store instruction 550. Each of the instruction headers or instructions is labeled according to the number of bits. For example the instruction header 510 includes four 32-bit words and is labeled from its least significant bit (lsb) (bit 0) up to its most significant bit (msb) (bit 127). As shown, the instruction header includes a write mask field, a store mask field, a number of exit type fields, a number of execution flag fields (X flags), an instruction block size field, and an instruction header ID bit (the least significant bit of the instruction header).

The execution flag fields can indicate special instruction execution modes. For example, an “inhibit branch predictor” flag can be used to inhibit branch prediction for the instruction block when the flag is set. As another example, an “inhibit memory dependence prediction” flag can be used to inhibit memory dependence prediction for the instruction block when the flag is set. As another example, a “break after block” flag can be used to halt an instruction thread and raise an interrupt when the instruction block is committed. As another example, a “break before block” flag can be used to halt an instruction thread and raise an interrupt when the instruction block header is decoded and before the instructions of the instruction block are executed. As another example, a “data prefetching disable” flag can be used to control whether data prefetching is enabled or disabled for the instruction block.

The exit type fields include data that can be used to indicate the types of control flow and/or synchronization instructions encoded within the instruction block. For example, the exit type fields can indicate that the instruction block includes one or more of the following: sequential branch instructions, offset branch instructions, indirect branch instructions, call instructions, return instructions, and/or break instructions. In some examples, the branch instructions can be any control flow instructions for transferring control flow between instruction blocks, including relative and/or absolute addresses, and using a conditional or unconditional predicate. The exit type fields can be used for branch prediction and speculative execution in addition to determining implicit control flow instructions. In some examples, up to six exit types can be encoded in the exit type fields, and the correspondence between fields and corresponding explicit or implicit control flow instructions can be determined by, for example, examining control flow instructions in the instruction block.

The illustrated generic block instruction 520 is stored as one 32-bit word and includes an opcode field, a predicate field, a broadcast ID field (BID), a first target field (T1), and a second target field (T2). For instructions with more consumers than target fields, a compiler can build a fanout tree using move instructions, or it can assign high-fanout instructions to broadcasts. Broadcasts support sending an operand over a lightweight network to any number of consumer instructions in a core. A broadcast identifier can be encoded in the generic block instruction 520.

While the generic instruction format outlined by the generic instruction 520 can represent some or all instructions processed by a block-based processor, it will be readily understood by one of skill in the art that, even for a particular example of an ISA, one or more of the instruction fields may deviate from the generic format for particular instructions. The opcode field specifies the length or width of the instruction 520 and the operation(s) performed by the instruction 520, such as memory read/write, register load/store, add, subtract, multiply, divide, shift, rotate, system operations, or other suitable instructions.

The predicate field specifies the condition under which the instruction will execute. For example, the predicate field can specify the value “true,” and the instruction will only execute if a corresponding condition flag matches the specified predicate value. In some examples, the predicate field specifies, at least in part, a field, operand, or other resource which is used to compare the predicate, while in other examples, the execution is predicated on a flag set by a previous instruction (e.g., the preceding instruction in the instruction block). In some examples, the predicate field can specify that the instruction will always, or never, be executed. Thus, use of the predicate field can allow for denser object code, improved energy efficiency, and improved processor performance, by reducing the number of branch instructions.

The target fields T1 and T2 specifying the instructions to which the results of the block-based instruction are sent. For example, an ADD instruction at instruction slot 5 can specify that its computed result will be sent to instructions at slots 3 and 10. Depending on the particular instruction and ISA, one or both of the illustrated target fields can be replaced by other information, for example, the first target field T1 can be replaced by an immediate operand, an additional opcode, specify two targets, etc.

The branch instruction 530 includes an opcode field, a predicate field, a broadcast ID field (BID), and an offset field. The opcode and predicate fields are similar in format and function as described regarding the generic instruction. The offset can be expressed in units of four instructions, thus extending the memory address range over which a branch can be executed. The predicate shown with the generic instruction 520 and the branch instruction 530 can be used to avoid additional branching within an instruction block. For example, execution of a particular instruction can be predicated on the result of a previous instruction (e.g., a comparison of two operands). If the predicate is false, the instruction will not commit values calculated by the particular instruction. If the predicate value does not match the required predicate, the instruction does not issue. For example, a BRO_F (predicated false) instruction will issue if it is sent a false predicate value.

It should be readily understood that, as used herein, the term “branch instruction” is not limited to changing program execution to a relative memory location, but also includes jumps to an absolute or symbolic memory location, subroutine calls and returns, and other instructions that can modify the execution flow. In some examples, the execution flow is modified by changing the value of a system register (e.g., a program counter PC or instruction pointer), while in other examples, the execution flow can be changed by modifying a value stored at a designated location in memory. In some examples, a jump register branch instruction is used to jump to a memory location stored in a register. In some examples, subroutine calls and returns are implemented using jump and link and jump register instructions, respectively.

The load instruction 540 is used for retrieving data from memory into a processor core. The address of the data can be calculated dynamically at runtime. For example, the address can be a sum of an operand of the load instruction 540 and an immediate field of the load instruction 540. As another example, the address can be a sum of an operand of the load instruction 540 and a sign-extended and/or shifted immediate field of the load instruction 540. As another example, the address of the data can be a sum of two operands of the load instruction 540. The load instruction 540 can include a load-store identifier field (LSID) to provide a relative ordering of the load within an instruction block. For example, the compiler can assign an LSID to each load and store of the instruction block at compile-time. The amount and type of data can be retrieved and/or formatted in various ways. For example, the data can be formatted as a signed or unsigned value and the amount or size of the data retrieved can vary. Different opcodes can be used to identify the type of load instruction 540, such as a load unsigned byte, load signed byte, load double-word, load unsigned half-word, load signed half-word, load unsigned word, and load signed word, for example. The output of the load instruction 540 can be directed to a target instruction as indicated by a target field (T0).

A predicated load instruction is a load instruction that conditionally executes based on whether a result associated with the instruction matches a predicate test value. For example, the result can be delivered to an operand of the predicated load instruction from another instruction, and the predicate test value can be encoded in a field of the predicated load instruction. As a specific example, the load instruction 540 can be a predicated load instruction when one or more bits of the predicate field (PR) are non-zero. For example, the predicate field can be two bits wide where one bit is used to indicate that the instruction is predicated and one bit is used to indicate the predicate test value. Specifically, the encodings “00” can indicate the load instruction 540 is not predicated; “10” can indicate the load instruction 540 is predicated on a false condition (e.g., the predicate test value is a “0”); “11” can indicate the load instruction 540 is predicated on a true condition (e.g., the predicate test value is a “0”); and “10” can be reserved. Thus, a two-bit predicate field can be used to compare a received result to a true or false condition. A wider predicate field can be used to compare the received result to a larger number.

In one example, the result to be compared to the predicate test value can be passed to the instruction via one or more broadcast operands or channels. The broadcast channel of the predicate can be identified within the load instruction 540 using a broadcast identifier field (BID). For example, the broadcast identifier field can be two-bits wide to encode four possible broadcast channels on which to receive the value to compare to the predicate test value. As a specific example, if the value received on the identified broadcast channel matches the predicate test value, the load instruction 540 is executed. However, if the value received on the identified broadcast channel does not match the predicate test value, the load instruction 540 is not executed.

The load instruction 540 can be relatively slow to execute compared to other instructions because it is used to retrieve data from memory, and memory accesses can be relatively slow. For example, operations that occur entirely within a processor core can be relatively faster because the logic circuits of the processor core are relatively closer together and faster than the circuits in main memory. Memory may be shared by multiple processor cores of a processor, so it can be relatively far from a particular processor core and the memory may be larger than a processor core making it relatively slower.

A memory hierarchy can be used to potentially increase the speed of accessing data stored in the memory. A memory hierarchy includes multiple levels of memory having different speeds and sizes. Levels within or closer to the processor core are generally faster and smaller than levels farther from the processor core. For example, a memory hierarchy can include a level-one (L1) cache within a processor core, a level-two (L2) cache within a processor that is shared by multiple processor cores, main memory that is off-chip or external to the processor, and backing store that is located on a storage device, such as a hard-disk drive. Data can be copied from a slower level of the hierarchy to a faster level of the hierarchy when the data will be or is likely to be used by a processor core. The data can be copied in blocks or lines that contain multiple words of data corresponding to a range of memory addresses. For example, a memory line can be copied or fetched from main memory into an L2 and/or L1 cache to increase the execution speed of instructions that access memory locations within the memory line. A principle of locality indicates that a program tends to use memory locations that are close to other memory locations used by the program (spatial locality) and that a given memory location is likely to be used multiple times by the program within a short time period (temporal locality). Thus, copying a memory line associated with an address of one instruction into a high-speed cache may also increase the execution speed of other instructions that access other locations within the cached memory line. However, the faster levels of the memory hierarchy likely have reduced storage capacity compared to the slower levels of the memory hierarchy. Thus, copying a new memory line into the cache will typically cause a different memory line to be displaced or evicted. Policies can be implemented to balance the risk of evicting data that is likely to be reused by the instructions of an instruction block with the goal of prefetching data that will be used by the instructions.

The execution speed of the load instruction 540 can potentially be increased by prefetching the data from memory prior to the load instruction 540 being executed. Prefetching the data can include copying data associated with the load address from a slower level of the memory hierarchy into a faster level of the memory hierarchy before the load instruction 540 is executed. Thus, the data can potentially be accessed from the faster level of the memory hierarchy during execution of the load instruction 540 which can speed up the execution of the load instruction 540. A predicated load instruction may provide more opportunities for prefetching data than a non-predicated load instruction because the additional predicate calculation may delay when the predicated load instruction is ready to issue. However, a predicated load instruction may also provide more risks with prefetching data than a non-predicated load instruction because the predicated load instruction will not execute if the predicate condition is not met and any prefetched data can potentially evict data that is used within the instruction block. A compiler can potentially detect cases where prefetching the data exceeds a risk threshold and can pass this information to a processor core via an enable field for enabling prefetching of data. For example, the opcode field can include an optional enable field (EN) for controlling whether load data can be prefetched before the load instruction 540 executes.

As a specific example of a 32-bit load instruction 540, the opcode field can be encoded in bits [31:25]; the predicate field can be encoded in bits [24:23]; the broadcast identifier field can be encoded in bits [22:21]; the LSID field can be encoded in bits [20:16]; the immediate field can be encoded in bits [15:9]; and the target field can be encoded in bits [8:0].

The store instruction 550 is used for storing data to memory. The address of the data can be calculated dynamically at runtime. For example, the address can be a sum of a first operand of the store instruction 550 and an immediate field of the store instruction 550. As another example, the address can be a sum of an operand of the store instruction 550 and a sign-extended and/or shifted immediate field of the store instruction 550. As another example, the address of the data can be a sum of two operands of the store instruction 550. The store instruction 550 can include a load-store identifier field (LSID) to provide a relative ordering of the store within an instruction block. The amount of data to be stored can vary based on an opcode of the store instruction 550, such as a store byte, store half-word, store word, and store double-word, for example. The data to be stored at the memory location can be input from a second operand of the store instruction 550. The second operand can be generated by another instruction or encoded as a field of the store instruction 550.

A predicated store instruction is a store instruction that conditionally executes based on whether a result associated with the instruction matches a predicate test value. For example, the result can be delivered to an operand of the predicated store instruction from another instruction, and the predicate test value can be encoded in a field of the predicated store instruction. For example, the store instruction 550 can be a predicated store instruction when one or more bits of the predicate field (PR) are non-zero. The result to be compared to the predicate test value can be passed to the instruction via one or more broadcast operands or channels. The broadcast channel of the predicate can be identified within the store instruction 550 using a broadcast identifier field (BID). As a specific example, if the value received on the identified broadcast channel matches the predicate test value, the store instruction 550 is executed. However, if the value received on the identified broadcast channel does not match the predicate test value, the store instruction 550 is not executed.

Similar to the load instruction 540, executing the store instruction 550 can be relatively slow compared to executing other instructions because it may include retrieving data from memory, and memory accesses can be relatively slow. Specifically, the store instruction 550 will retrieve a memory line associated with the targeted address when there is a cache miss and the cache policy is a write-back, write-allocate policy. A cache can implement different policies when writing or storing data to a memory location, such as the write-through and write-back policies. When writing data using a write-through cache policy, the data is written to the cache and to the backing store. When writing data using a write-back cache policy, the data is written only to the cache and not to the backing store until the cache line holding the data is evicted from the cache. A cache can implement different policies when write data misses in the cache, such as the write-allocate and write-no-allocate policies. When write data misses in the cache using a write-allocate cache policy, the line spanning the address of the write data is brought into the cache. When write data misses in the cache using a write-no-allocate cache policy, the line spanning the address of the write data is not brought into the cache.

The execution speed of the store instruction 550 can potentially be increased by prefetching the data from memory prior to the store instruction 550 being executed. For example, the data can be prefetched from memory prior to a predicate value of the store instruction 550 being executed. Prefetching the data can include copying data associated with the load address from a slower level of the memory hierarchy into a faster level of the memory hierarchy before the store instruction 550 is executed. The opcode field can include an optional enable field (EN) for controlling whether data at the targeted store address can be prefetched before the store instruction 550 executes. For example, the EN field can be cleared, indicating not to prefetch, when a write-through cache policy is used.

As a specific example of a 32-bit store instruction 550, the opcode field can be encoded in bits [31:25]; the predicate field can be encoded in bits [24:23]; the broadcast identifier field can be encoded in bits [22:21]; the LSID field can be encoded in bits [20:16]; the immediate field can be encoded in bits [15:9]; and the optional enable field can be encoded in bit [0]. The bits [8:1] can be reserved for additional functions or for future use.

### VIII. Example States of a Processor Core

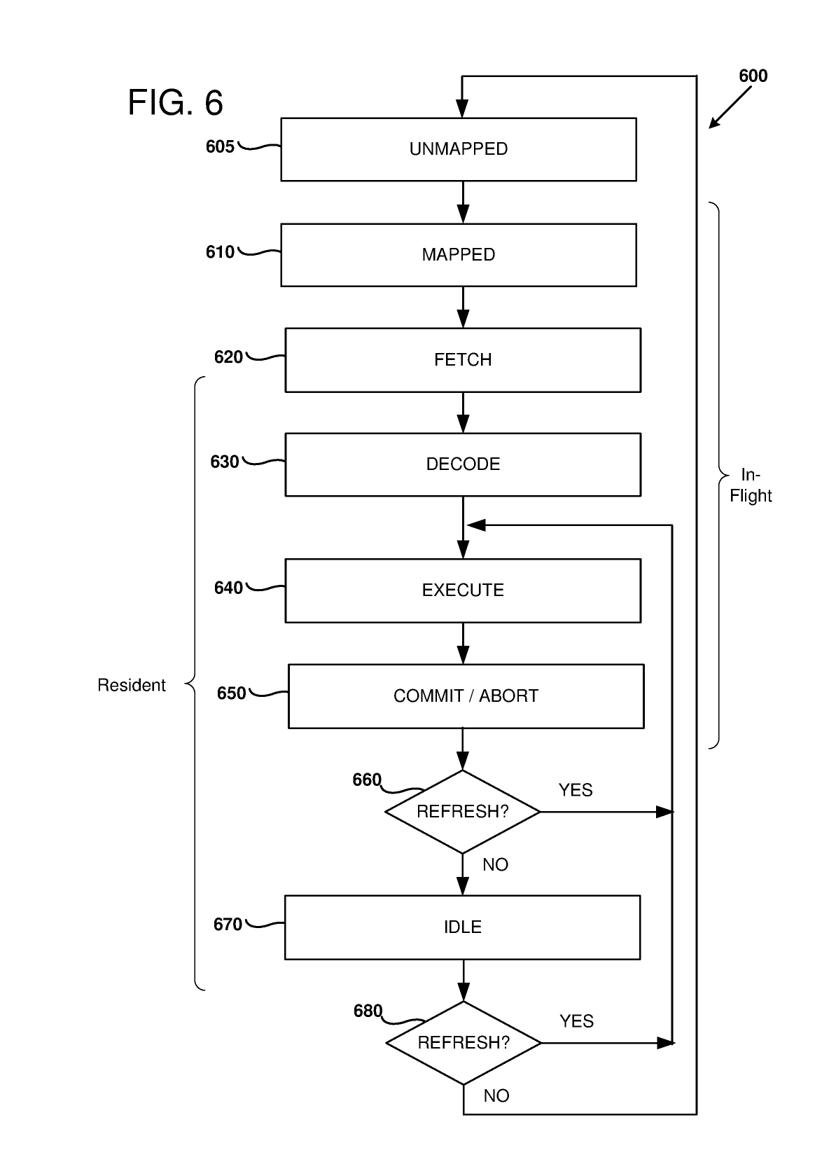

FIG. 6 is a flowchart illustrating an example of a progression of states 600 of a processor core of a block-based computer. The block-based computer is composed of multiple processor cores that are collectively used to run or execute a software program. The program can be written in a variety of high-level languages and then compiled for the block-based processor using a compiler that targets the block-based processor. The compiler can emit code that, when run or executed on the block-based processor, will perform the functionality specified by the high-level program. The compiled code can be stored in a computer-readable memory that can be accessed by the block-based processor. The compiled code can include a stream of instructions grouped into a series of instruction blocks. During execution, one or more of the instruction blocks can be executed by the block-based processor to perform the functionality of the program. Typically, the program will include more instruction blocks than can be executed on the cores at any one time. Thus, blocks of the program are mapped to respective cores, the cores perform the work specified by the blocks, and then the blocks on respective cores are replaced with different blocks until the program is complete. Some of the instruction blocks may be executed more than once, such as during a loop or a subroutine of the program. An “instance” of an instruction block can be created for each time the instruction block will be executed. Thus, each repetition of an instruction block can use a different instance of the instruction block. As the program is run, the respective instruction blocks can be mapped to and executed on the processor cores based on architectural constraints, available hardware resources, and the dynamic flow of the program. During execution of the program, the respective processor cores can transition through a progression of states 600, so that one core can be in one state and another core can be in a different state.

At state 605, a state of a respective processor core can be unmapped. An unmapped processor core is a core that is not currently assigned to execute an instance of an instruction block. For example, the processor core can be unmapped before the program begins execution on the block-based computer. As another example, the processor core can be unmapped after the program begins executing but not all of the cores are being used. In particular, the instruction blocks of the program are executed, at least in part, according to the dynamic flow of the program. Some parts of the program may flow generally serially or sequentially, such as when a later instruction block depends on results from an earlier instruction block. Other parts of the program may have a more parallel flow, such as when multiple instruction blocks can execute at the same time without using the results of the other blocks executing in parallel. Fewer cores can be used to execute the program during more sequential streams of the program and more cores can be used to execute the program during more parallel streams of the program.

At state 610, the state of the respective processor core can be mapped. A mapped processor core is a core that is currently assigned to execute an instance of an instruction block. When the instruction block is mapped to a specific processor core, the instruction block is in-flight. An in-flight instruction block is a block that is targeted to a particular core of the block-based processor, and the block will be or is executing, either speculatively or non-speculatively, on the particular processor core. In particular, the in-flight instruction blocks correspond to the instruction blocks mapped to processor cores in states 610-650. A block executes non-speculatively when it is known during mapping of the block that the program will use the work provided by the executing instruction block. A block executes speculatively when it is not known during mapping whether the program will or will not use the work provided by the executing instruction block. Executing a block speculatively can potentially increase performance, such as when the speculative block is started earlier than if the block were to be started after or when it is known that the work of the block will be used. However, executing speculatively can potentially increase the energy used when executing the program, such as when the speculative work is not used by the program.

A block-based processor includes a finite number of homogeneous or heterogeneous processor cores. A typical program can include more instruction blocks than can fit onto the processor cores. Thus, the respective instruction blocks of a program will generally share the processor cores with the other instruction blocks of the program. In other words, a given core may execute the instructions of several different instruction blocks during the execution of a program. Having a finite number of processor cores also means that execution of the program may stall or be delayed when all of the processor cores are busy executing instruction blocks and no new cores are available for dispatch. When a processor core becomes available, an instance of an instruction block can be mapped to the processor core.

An instruction block scheduler can assign which instruction block will execute on which processor core and when the instruction block will be executed. The mapping can be based on a variety of factors, such as a target energy to be used for the execution, the number and configuration of the processor cores, the current and/or former usage of the processor cores, the dynamic flow of the program, whether speculative execution is enabled, a confidence level that a speculative block will be executed, and other factors. An instance of an instruction block can be mapped to a processor core that is currently available (such as when no instruction block is currently executing on it). In one embodiment, the instance of the instruction block can be mapped to a processor core that is currently busy (such as when the core is executing a different instance of an instruction block) and the later-mapped instance can begin when the earlier-mapped instance is complete.

At state 620, the state of the respective processor core can be fetch. For example, the IF pipeline stage of the processor core can be active during the fetch state. Fetching an instruction block can include transferring instructions of the block from memory (such as the L1 cache, the L2 cache, or main memory) to the processor core, and reading instructions from local buffers of the processor core so that the instructions can be decoded. For example, the instructions of the instruction block can be loaded into an instruction cache, buffer, or registers of the processor core. Multiple instructions of the instruction block can be fetched in parallel (e.g., at the same time) during the same clock cycle. The fetch state can be multiple cycles long and can overlap with the decode (630) and execute (640) states when the processor core is pipelined.

When instructions of the instruction block are loaded onto the processor core, the instruction block is resident on the processor core. The instruction block is partially resident when some, but not all, instructions of the instruction block are loaded. The instruction block is fully resident when all instructions of the instruction block are loaded. The instruction block will be resident on the processor core until the processor core is reset or a different instruction block is fetched onto the processor core. In particular, an instruction block is resident in the processor core when the core is in states 620-670.

At state 630, the state of the respective processor core can be decode. For example, the DC pipeline stage of the processor core can be active during the fetch state. During the decode state, instructions of the instruction block are being decoded so that they can be stored in the memory store of the instruction window of the processor core. In particular, the instructions can be transformed from relatively compact machine code, to a less compact representation that can be used to control hardware resources of the processor core. Predicated load and predicated store instructions can be identified during the decode state. The decode state can be multiple cycles long and can overlap with the fetch (620) and execute (640) states when the processor core is pipelined. After an instruction of the instruction block is decoded, it can be executed when all dependencies of the instruction are met.

At state 640, the state of the respective processor core can be execute. During the execute state, instructions of the instruction block are being executed. In particular, the EX and/or LS pipeline stages of the processor core can be active during the execute state. Data associated with load and/or store instructions can be fetched and/or pre-fetched during the execute state. The instruction block can be executing speculatively or non-speculatively. A speculative block can execute to completion or it can be terminated prior to completion, such as when it is determined that work performed by the speculative block will not be used. When an instruction block is terminated, the processor can transition to the abort state. A speculative block can complete when it is determined the work of the block will be used, all register writes are buffered, all writes to memory are buffered, and a branch target is calculated, for example. A non-speculative block can execute to completion when all register writes are buffered, all writes to memory are buffered, and a branch target is calculated, for example. The execute state can be multiple cycles long and can overlap with the fetch (620) and decode (630) states when the processor core is pipelined. When the instruction block is complete, the processor can transition to the commit state.

At state 650, the state of the respective processor core can be commit or abort. During commit, the work of the instructions of the instruction block can be atomically committed so that other blocks can use the work of the instructions. In particular, the commit state can include a commit phase where locally buffered architectural state is written to architectural state that is visible to or accessible by other processor cores. When the visible architectural state is updated, a commit signal can be issued and the processor core can be released so that another instruction block can be executed on the processor core. During the abort state, the pipeline of the core can be halted to reduce dynamic power dissipation. In some applications, the core can be power gated to reduce static power dissipation. At the conclusion of the commit/abort states, the processor core can receive a new instruction block to be executed on the processor core, the core can be refreshed, the core can be idled, or the core can be reset.

At state 660, it can be determined if the instruction block resident on the processor core can be refreshed. As used herein, an instruction block refresh or a processor core refresh means enabling the processor core to re-execute one or more instruction blocks that are resident on the processor core. In one embodiment, refreshing a core can include resetting the active-ready state for one or more instruction blocks. It may be desirable to re-execute the instruction block on the same processor core when the instruction block is part of a loop or a repeated sub-routine or when a speculative block was terminated and is to be re-executed. The decision to refresh can be made by the processor core itself (contiguous reuse) or by outside of the processor core (non-contiguous reuse). For example, the decision to refresh can come from another processor core or a control core performing instruction block scheduling. There can be a potential energy savings when an instruction block is refreshed on a core that already executed the instruction as opposed to executing the instruction block on a different core. Energy is used to fetch and decode the instructions of the instruction block, but a refreshed block can save most of the energy used in the fetch and decode states by bypassing these states. In particular, a refreshed block can re-start at the execute state (640) because the instructions have already been fetched and decoded by the core. When a block is refreshed, the decoded instructions and the decoded ready state can be maintained while the active ready state is cleared. The decision to refresh an instruction block can occur as part of the commit operations or at a later time. If an instruction block is not refreshed, the processor core can be idled.

At state 670, the state of the respective processor core can be idle. The performance and power consumption of the block-based processor can potentially be adjusted or traded off based on the number of processor cores that are active at a given time. For example, performing speculative work on concurrently running cores may increase the speed of a computation but increase the power if the speculative misprediction rate is high. As another example, immediately allocating new instruction blocks to processors after committing or aborting an earlier executed instruction block may increase the number of processors executing concurrently, but may reduce the opportunity to reuse instruction blocks that were resident on the processor cores. Reuse may be increased when a cache or pool of idle processor cores is maintained. For example, when a processor core commits a commonly used instruction block, the processor core can be placed in the idle pool so that the core can be refreshed the next time that the same instruction block is to be executed. As described above, refreshing the processor core can save the time and energy used to fetch and decode the resident instruction block. The instruction blocks/processor cores to place in an idle cache can be determined based on a static analysis performed by the compiler or a dynamic analysis performed by the instruction block scheduler. For example, a compiler hint indicating potential reuse of the instruction block can be placed in the header of the block and the instruction block scheduler can use the hint to determine if the block will be idled or reallocated to a different instruction block after committing the instruction block. When idling, the processor core can be placed in a low-power state to reduce dynamic power consumption, for example.

At state 680, it can be determined if the instruction block resident on the idle processor core can be refreshed. If the core is to be refreshed, the block refresh signal can be asserted and the core can transition to the execute state (640). If the core is not going to be refreshed, the block reset signal can be asserted and the core can transition to the unmapped state (605). When the core is reset, the core can be put into a pool with other unmapped cores so that the instruction block scheduler can allocate a new instruction block to the core.

### IX. Examples of Block-Based Compiler Methods

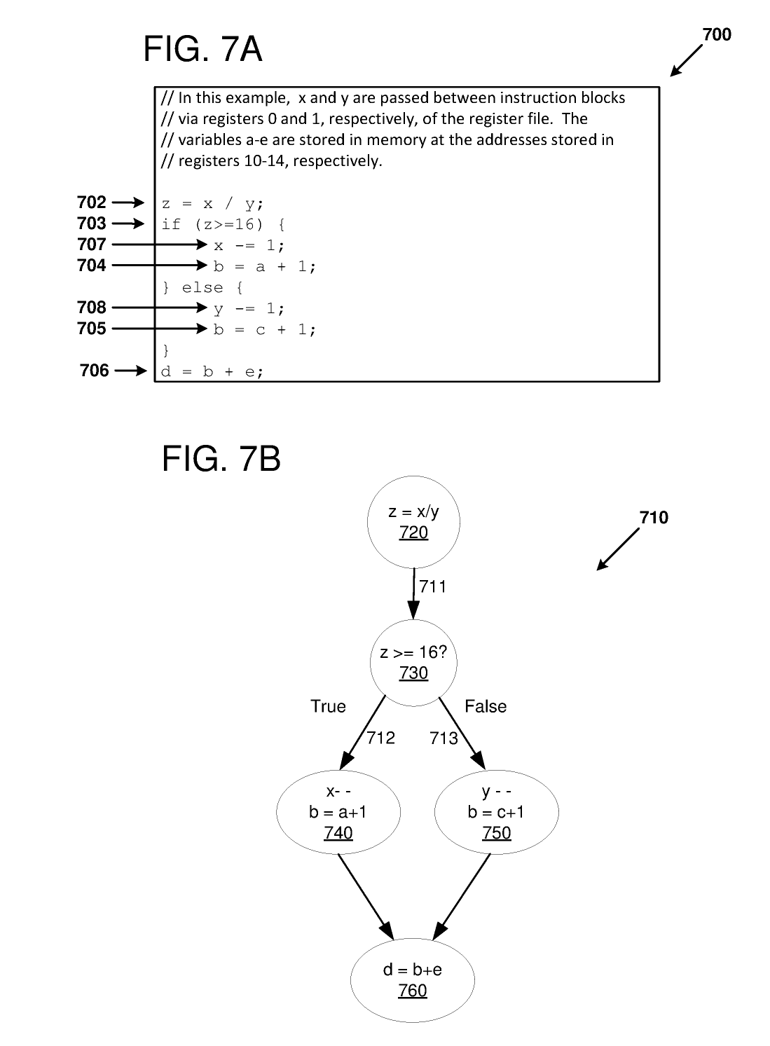

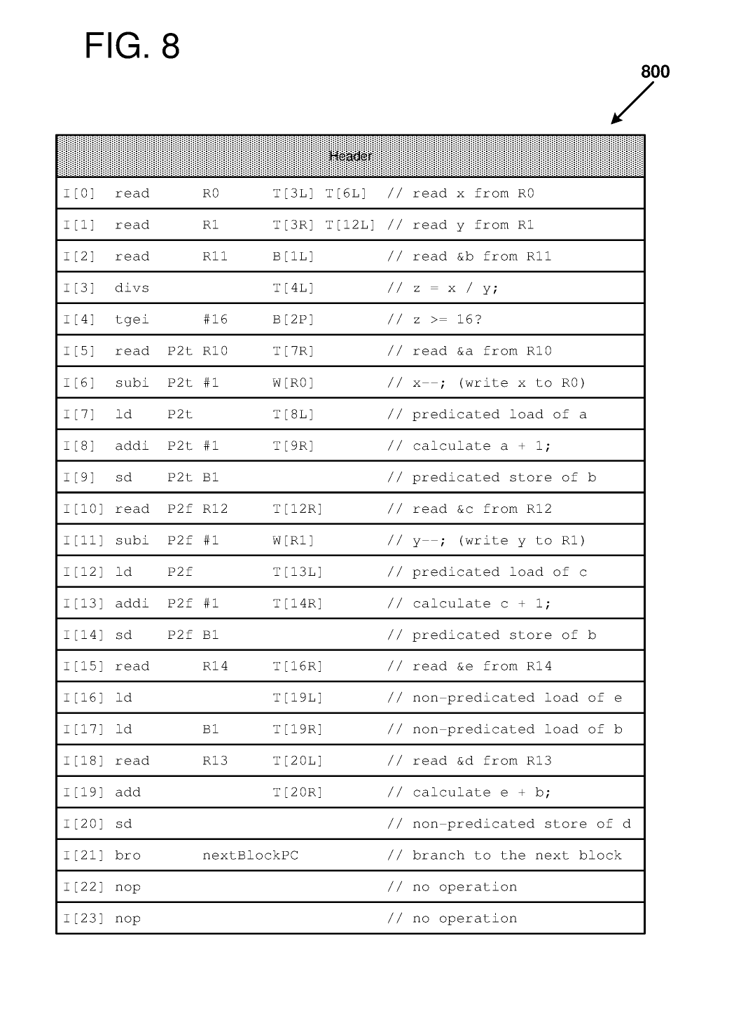

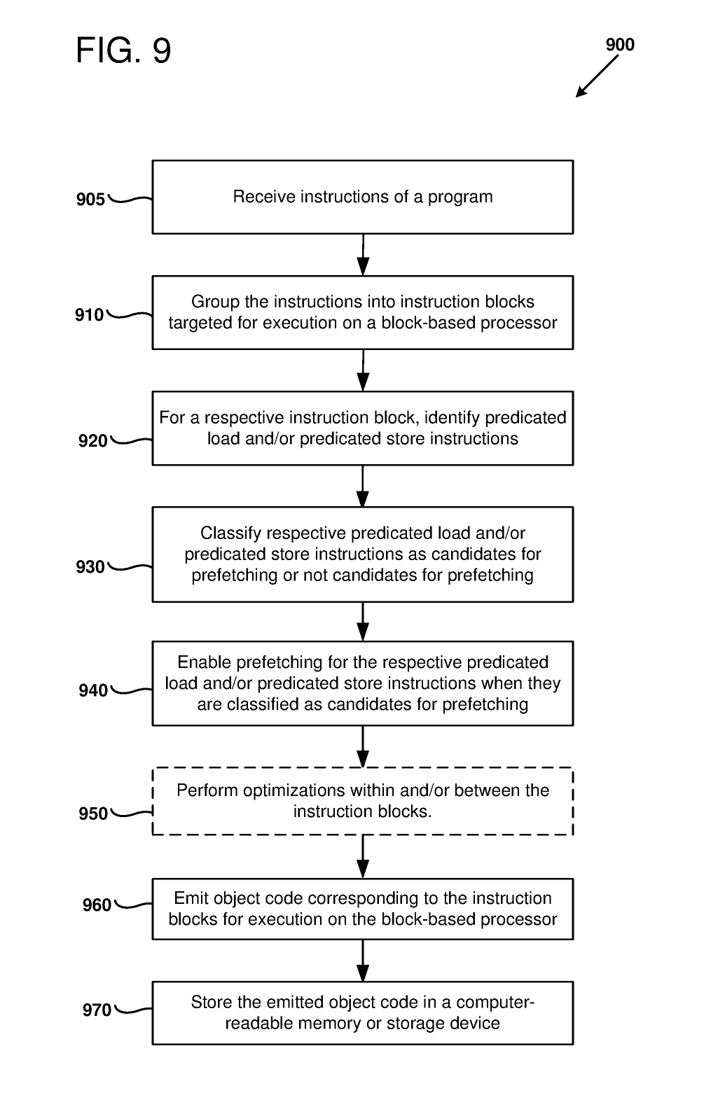

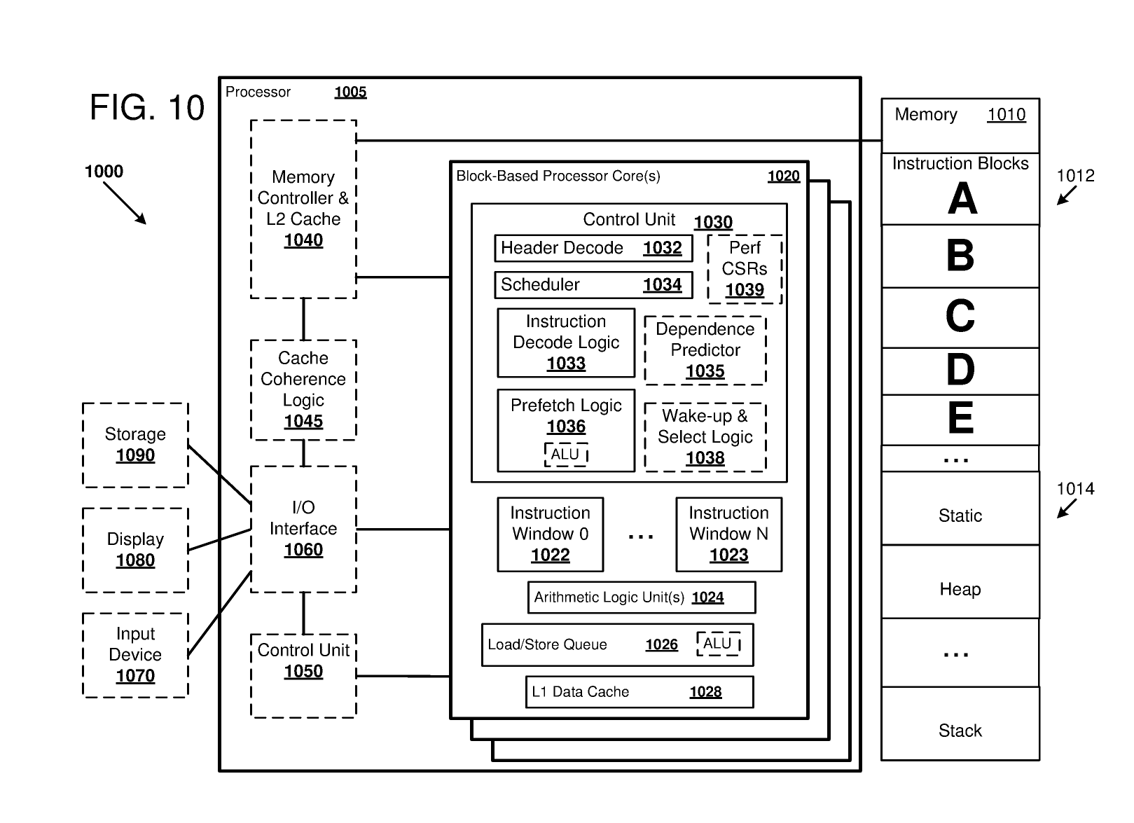

FIG. 7A is an example snippet of source code 700 of a program for a block-based processor. FIG. 7B is an example of a dependence graph 710 of the example snippet of source code 700. FIG. 8 illustrates an example instruction block corresponding to the snippet of source code from FIG. 7A, where the instruction block comprises predicated load instructions and predicated store instructions. FIG. 9 is a flowchart illustrating an example method of compiling a program for a block-based processor.

In FIG. 7A, the source code 700 comprising source code statements 702-708 can be compiled or transformed into an instruction block that can be atomically executed on a block-based processor core of a processor. In this example, the variable z is a local variable of the instruction block and so its value can be calculated by one instruction of the instruction block and passed to other instructions of the instruction block without updating architectural state that is visible outside of the block-based processor core that the instruction block is executing on. The variables x and y are used to pass values between different instruction blocks using the registers R0 and R1, respectively. The variables a-e are stored in memory. The addresses of the memory locations are stored registers R10-R14, respectively.

Compiling the source code can include generating the dependence graph 710 by analyzing the source code 700, and emitting instructions of the instruction block using the dependence graph 710. The dependence graph 710 can be a single directed acyclic graph (DAG) or a forest of DAGs. The nodes (e.g., 720, 730, 740, 750, and 760) of the dependence graph 710 can represent operations to perform the function of the source code 700. For example, the nodes can directly correspond to operations to be performed by the processor core. Alternatively, the nodes can correspond to macro- or micro-operations to be performed by the processor core. The directed edges (e.g., 711, 712, and 713) connecting the nodes represent dependencies between the nodes. Specifically, consumer or target nodes are dependent on producer nodes generating a result, and thus producer nodes are executed before consumer nodes. The directed edges point from the producer node to the consumer node. In the block-atomic execution model, intermediate results are visible only within the processor core and final results are made visible to all of the processor cores when the instruction block is committed. The nodes 720 and 730 produce intermediate results and the nodes 740, 750, and 760 may produce final results.

As a specific example, the dependence graph 710 can be generated from at least the snippet of source code 700. It should be noted that in this example, there are more statements of the source code 700 than nodes of the dependence graph 710. However, a dependence graph may generally have fewer, the same, or more nodes than the statements of the source code used to generate the dependence graph. The statement 702 generates the node 720 of the dependence graph 710. The node 720 calculates or produces a variable z which is consumed by the node 730 as represented by the edge 711. The statement 703 generates the node 730 of the dependence graph 710, where the variable z is compared to a predicate test value (e.g., a constant 16) to generate a predicate value of true or false. If the predicate value is true, the node 740 is executed (as represented by the edge 712), but if the predicate value is false, the node 750 is executed (as represented by the edge 713). The statements 704 and 707 generate the node 740 and the statements 705 and 708 generate the nodes 750. Nodes 740 and 750 each include a predicated load and a predicated store. For example, in node 740, reading the variable a and storing the incremented value of a is predicated on the variable z being greater than or equal to 16. As another example, in node 750, reading the variable c and storing the incremented value of c is predicated on the variable z being less than 16. The value of b generated by either node 740 or 750 is consumed by the node 760, which is generated by the statement 706. The value of b can be passed directly from the generating instruction to the consuming instruction or the value of b can be passed indirectly from the generating instruction to the consuming instruction, such as via a load-store queue. Node 760 includes a non-predicated load and a non-predicated store. Specifically, the value of variable e is always loaded and the value of variable d is always stored when the instruction block is executed.

FIG. 8 is an example instruction block 800 corresponding to the snippet of source code 700 from FIG. 7A. The instruction block 800 can be generated by performing a traversal of the dependence graph 710 and emitting instructions corresponding to each node of the dependence graph 710. Thus, the instructions of the instruction block 800 can be emitted in a particular order based on how the dependence graph 710 is traversed. Optimizations can be performed on the emitted instructions, such as removing redundant or dead code, eliminating common sub-expressions, and re-ordering instructions for more efficient usage of hardware resources. In a conventional non-block-based processor, dependencies between instructions are maintained by the ordering of the instructions, such that dependent instructions must come after the instructions they depend upon. In contrast, the instructions within an instruction block to be executed on a block-based processor can be emitted in any order because the dependencies are encoded within the instructions themselves and not in the order of the instructions. Specifically, the instruction scheduling logic of the block-based processor can ensure the proper order of execution because the scheduling logic will only issue instructions for execution when the dependencies of the instructions are satisfied. Thus, a compiler targeting a block-based processor may have more degrees of freedom in which to order the emitted instructions within the instruction block. For example, the instructions can be ordered based on various criteria, such as: a size of the instruction when the instructions have variable lengths (so that like-sized instructions are grouped together or so that the instructions maintain a particular alignment within the instruction block); a mapping of machine code instructions to source code statements; a type of the instruction (so that like-type instructions (e.g., having the same opcode) are grouped together or some types of instructions are ordered before other types); an execution time of the instruction (so that relatively time consuming instructions or instruction paths may be executed before quicker instructions or instruction paths); and/or a traversal of the dependence graph 710.

The emitted order of the instructions of the instruction block 800 generally follows a breadth-first traversal of the dependence graph 710, but with some example optimizations for reading the addresses of the variables stored in memory earlier than when using a pure breadth-first traversal. As described above, the order of the instructions does not, by itself, determine the order that the instructions of the atomic instruction block 800 are executed. However, by ordering an instruction earlier in the instruction block, the instruction may be decoded earlier and may be available for instruction dispatch earlier than if the instruction is ordered later in the instruction block.

Instructions I[0] and I[1] are used for reading the values of the variables x and y from the register file. Instruction I[2] is used to read the address of the variable b and to transmit the address of the variable b on broadcast channel 1. Moving the reading of the address of the variable b from both of the predicated paths is an optimization that can potentially reduce code size (by replacing two predicated reads of register R11 with a single read of register R11) and can potentially increase the speed of writing to the memory location corresponding to the variable b. For example, once instruction I[2] is executed and the address of the variable b is known, the data at the address of the variable b can be prefetched in preparation for the predicated store of the variable b in instruction I[9] or I[14], such as when the cache policy is write allocate. For example, the prefetching can be initiated before the predicate value is calculated at instruction I[4] and during execution of the potentially multi-cycle divide operation of instruction I[3].

The instruction I[4] is used for the predicate calculation. Specifically, the result of the instruction I[3] is compared to the predicate test value, 16, and the predicate result is transmitted on broadcast channel 2. The instructions I[5]-I[9] execute only if the predicate result is true (e.g., z>=16) and instructions I[10]-I[14] execute only if the predicate result is false (e.g., z<16). In the assembly language of the instruction block 800, “P2f” indicates the instruction is predicated (the “P”) on a false result (the “f”) being transmitted on broadcast channel 2 (the “2”), and “P2t” indicates the instruction is predicated on a true result being transmitted on broadcast channel 2.

The instruction I[7] is a predicated load of the variable a. The execution speed of the predicated load may be increased if the data located at the memory location of a is prefetched. The data can be prefetched after the address of the variable a is calculated or read from a register. As one example, the memory address of the variable a can be read from a register using the instruction I[5]. Thus, prefetching the data can be initiated before the variable x is decremented using the instruction I[6] and the predicated load is executed using the instruction I[7]. An example of a compiler optimization can be moving the instruction to determine the memory address of the variable a to an earlier point in the predicated path of execution so that the data can be prefetched earlier than if the instruction is not moved. In this example, the address of the variable a is moved to the first instruction of the predicated path of execution.

An alternative optimization (not shown) can be to “hoist” one or more of the instructions loading the variables a and c to before the predicate calculation. Specifically, the predicated load instructions can be converted to non-predicated load instructions and moved to before the predicate calculation. However, this optimization may complicate the compiler because the hoisted instructions are moved across a basic block boundary. Further, this optimization may potentially reduce performance and/or energy efficiency because the work from the hoisted instructions may not be used. Specifically, only one of the variables a and c are used for a given run of the instruction block. Hoisting the loading of both variables a and c ensures that the work from one of the loads will not be used. Hoisting the loading of only one of the variables a or c is effectively speculative because the wrong variable may be hoisted. Selecting the wrong instruction may also use memory bandwidth that could otherwise be used by a non-speculative instruction, which may delay the execution of the non-speculative instruction.

The instruction I[9] is a predicated store instruction that is used to store the result from the instruction I[8] into the memory location of the variable b when the predicate result from the instruction I[4] is true. The address of the variable b is determined by the instruction I[2] and sent on the broadcast channel 1. The processor core can store the operand for the instruction I[9] when the result from the instruction I[2] is sent on the broadcast channel 1. The instruction I[14] is another predicated store instruction that is used to store the result from the instruction I[13] into the memory location of the variable b when the predicate result from the instruction I[4] is false. Thus, only one of the predicated store instructions I[9] or I[14] will execute during a given run of the instruction block 800 because each of the predicated store instructions I[9] and I[14] is predicated on an opposite result of the predicate calculation. As described in more detail below, the output of the predicated store instruction is buffered locally within the processor core until a commit phase of the instruction block 800. When the instruction block 800 commits, the output of the predicated store instruction can update the memory location of the variable b and/or its corresponding entries within the memory hierarchy.

The instruction I[12] is a predicated load of the variable c. As with the predicated load of the variable a, the execution speed of the predicated load of the variable c may be increased if the data located at the memory location of c is prefetched. The data can be prefetched after the address of the variable c is calculated or read from a register. As one example, the memory address of the variable c can be read from a register using the instruction I[10]. Thus, prefetching the data can be initiated before the variable y is decremented using the instruction I[11] and the predicated load is executed using the instruction I[12].

The instruction I[16] is a non-predicated load of the variable e, and the address for the variable e is generated by the instruction I[15]. The execution speed of the load of the variable e may be increased if the data located at the memory location of e is prefetched. In this example, the address for the variable e is generated by the instruction preceding the non-predicated load of the variable e so that the instructions may be issued in close proximity. Alternatively, the compiler can move the address generating instruction earlier in the instruction block (such as before the predicate calculation) so that the processor core may have a greater opportunity to prefetch the data stored at the address of the variable e.

The instruction I[17] is a non-predicated load of the variable b, which was earlier stored by one of the predicated stores (instruction I[9] or I[14]). The instruction block 800 is an atomic instruction block and the instructions of the instruction block 800 commit together. Thus, the memory location of the variable b and/or its corresponding entries within the memory hierarchy are not updated until a commit phase of the instruction block 800. Thus, the output from the predicated store (instruction I[9] or I[14]) is buffered locally within the instruction block until the commit phase of the instruction block 800. For example, the output from the predicated store can be stored in a load-store queue of the processor core. Specifically, the output from the executed predicated store can be stored or buffered in the load-store queue and marked with a load-store identifier of the predicated store instruction. The buffered output from the predicated store instruction can be forwarded from the load-store queue to an operand of the instruction I[17].

The instruction I[20] is a non-predicated store instruction that is used to store the result from the instruction I[19] into the memory location of the variable d. The address of the variable d is determined by the instruction I[18] which reads the address from the register file. The execution speed of the store may be increased if the cache policy is write allocate and the data located at the memory location of d is prefetched. The data can be prefetched after the address of the variable d is calculated or read from a register. For example, once instruction I[19] is executed and the address of the variable d is known, the data at the address of the variable d can be prefetched in preparation for the non-predicated store of the variable d in instruction I[20]. For example, the prefetching can be initiated before instruction I[18] completes execution. The output of the store instruction is buffered locally, such as at the load-store queue within the processor core, until a commit phase of the instruction block 800. When the instruction block 800 commits, the output of the store instruction can update the memory location of the variable d and/or its corresponding entries within the memory hierarchy.

The instruction I[21] is an unconditional branch to the next instruction block. In some examples of the disclosed technology, an instruction block will have at least one branch to another instruction block of the program. The instructions I[22] and I[23] are no-operation instructions. These instructions perform no operation other than to pad the instruction block 800 to a multiple of four instruction words. In some examples of the disclosed technology, an instruction block is required to have a size that is a multiple of four instruction words.

FIG. 9 is a flowchart illustrating an example method 900 for compiling a program for a block-based computer architecture. The method 900 can be implemented in software of a compiler executing on a block-based processor or a conventional processor. The compiler can transform high-level source code (such as C, C++, or Java) of a program, in one or more phases or passes, into low-level object or machine code that is executable on the targeted block-based processor. For example, the compiler phases can include: lexical analysis for generating a stream of tokens from the source code; syntax analysis or parsing for comparing the stream of tokens to a grammar of the source code language and generating a syntax or parse tree; semantic analysis for performing various static checks (such as type-checking, checking that variables are declared, and so forth) on the syntax tree and generating an annotated or abstract syntax tree; generation of intermediate code from the abstract syntax tree; optimization of the intermediate code; machine code generation for producing the machine code for the targeted processor from the intermediate code; and optimization of the machine code. The machine code can be emitted and stored into a memory of the block-based processor so that the block-based processor can execute the program.

At process block 905, instructions of a program can be received. For example, the instructions can be received from a front-end of a compiler for transforming source code into machine code. Additionally or alternatively, the instructions can be loaded from a memory, a secondary storage device (such as a hard-disk drive), or from a communications interface (such as when the instructions are downloaded from a remote server computer). The instructions of the program may include metadata or data about the instructions, such as a break-point or a single-step starting point associated with an instruction.

At process block 910, the instructions can be grouped into instruction blocks targeted for execution on a block-based processor. For example, the compiler can generate machine code as a sequential stream of instructions which can be grouped into instruction blocks according to the block-based computer's hardware resources and the data and control flow of the code. For example, a given instruction block can include a single basic block, a portion of a basic block, or multiple basic blocks, so long as the instruction block can be executed within the constraints of the ISA and the hardware resources of the targeted computer. A basic block is a block of code where control can only enter the block at the first instruction of the block and control can only leave the block at the last instruction of the basic block. Thus, a basic block is a sequence of instructions that are executed together. Multiple basic blocks can be combined into a single instruction block using predicated instructions so that intra-instruction-block branches are converted to dataflow instructions.

The instructions can be grouped so that the resources of the processor cores are not exceeded and/or are efficiently utilized. For example, the processor cores can include a fixed number of resources, such as one or more instruction windows, a fixed number of load and store queue entries, and so forth. The instructions can be grouped to have fewer instructions per group than are available within an instruction window. For example, an instruction window may have storage capacity for 32 instructions, a first basic block may have 8 instructions, and the first basic block may conditionally branch to a second basic block having 23 instructions. The two basic blocks can be grouped together into one instruction block so that the grouping includes 31 instructions (less than the 32-instruction capacity) and the instructions of the second basic block are predicated on the branch condition being true. As another example, an instruction window may have storage capacity for 32 instructions and a basic block may have 38 instructions. The first 31 instructions can be grouped into one instruction block with an unconditional branch (the thirty-second instruction) and the next 7 instructions can be grouped into a second instruction block. As another example, an instruction window may have storage capacity for thirty-two instructions and a loop body may include eight instructions and be repeated three times. Grouping can include unrolling the loop by combining the multiple iterations of the loop body within a larger loop body. By unrolling the loop, the number of instructions within the instruction block can be increased and the instruction window resource can potentially be more efficiently utilized.

At process block 920, predicated load and/or predicated store instructions can be identified for a respective instruction block. A predicate load instruction is a load instruction that conditionally executes based on the result of a predicate calculation within the respective instruction block. Similarly, a predicate store instruction is a store instruction that conditionally executes based on the result of a predicate calculation within the respective instruction block. For example, the predicate calculation can be generated based on a condition or test within an “if,” “switch,” “while,” “do,” “for,” or other source code statement for modifying a control flow of a program. The grouping of the instructions in the process block 910 may affect which loads and stores are predicated loads and predicated stores. For example, grouping a single if-then-else statement within a single instruction block (as in the instruction block 800 of FIG. 8) may cause any loads and stores within the body of the if-then-else statement to be predicated loads and stores. Alternatively, grouping the statements of the body of the if clause in one instruction block (in a manner similar to the instruction block 425 of FIG. 4) and grouping the statements of the body of the else clause in a different instruction block may cause none of the loads and stores to be predicated loads and stores when the condition is calculated outside of the respective instruction blocks.

At process block 930, respective predicated load and/or predicated store instructions can be classified as candidates for prefetching or not candidates for prefetching. The classification can be based on various factors and/or combinations of factors, such as a static analysis of the instruction block, a likelihood that a branch will be taken, a source of the predicate calculation, a programmer hint, a static or dynamic analysis of a frequency of executing the instruction, a type of memory reference, and other factors that may affect the likelihood of using the prefetched data.

As one example, a respective instruction can be classified based on a static analysis of the instruction block. A static analysis is based on information about the instruction block that is available before any instructions of the instruction block are executed. For example, a static analysis can include determining a mix of arithmetic and logic unit (ALU) instructions to memory instructions. A static model of the processor core may include a desired ratio of ALU instructions to memory instructions, such as a 2:1 ratio of ALU/memory instructions. If the instruction mix of the instruction block is ALU-bound (there are more ALU instructions than desired when compared to the number of memory instructions), then prefetching may be more desirable. However, if the instruction mix of the instruction block is memory-bound, then prefetching may be less desirable. Thus, a respective instruction can be classified as a candidate for prefetching based on an instruction mix within the instruction block.

As another example, a respective instruction can be classified based on the likelihood that a branch will be taken. The likelihood that the branch will be taken can be based on a static or dynamic analysis. For example, a static analysis can be based on a source code statement generating the predicate calculation. As a specific example, a branch in a for loop may be more likely to be taken than a branch in an if-then-else statement. A dynamic analysis can use information from a profile generated during an earlier run of the program. Specifically, the program can be executed one or more times using representative data for the program to generate a profile comprising traces and/or statistics for the program and its instruction blocks. The profile may be generated by sampling performance counters or other state of the processor during the program run. The profile may include information such as which instruction blocks are executed, a frequency that respective instruction blocks are executed (such as to determine hot regions of the program), which branches are taken, a frequency that respective branches are taken, the results of predicate calculations, and so forth. The profile data can be used to guide or return information back to the compiler during recompilation of a program so that the program can potentially be made more efficient. In one embodiment, the loads and/or stores that are more likely than not to be executed can be classified as candidates for prefetching and the other loads and/or stores can be classified as not candidates for prefetching. In alternative embodiments, the likelihood to be executed can be reduced or increased to classify a particular load or store as a candidate for prefetching.

As another example, a programmer hint can be passed to the compiler via a compiler pragma or by using a particular system call, for example. As a specific example, the programmer can use a pragma defined by the compiler to specify that data prefetching is enabled and/or desired for a particular load, store, subroutine, section, or program. Additionally or alternatively, the programmer can specify that data prefetching is disabled or disfavored for a particular load, store, subroutine, section, or program. The programmer hint can be used exclusively to classify a particular load or store as a candidate for prefetching or it can be weighted with other factors for classifying a particular load or store.

As another example, a type of memory reference can be used to classify a particular load or store as a candidate for prefetching. In particular, memory accesses that are likely to miss in a cache of the processor core may benefit from prefetching. For example, memory accesses to the heap or indirect memory accesses within a linked data structure (e.g., pointer chasing) may be more likely to miss in the cache and may benefit from prefetching. Thus, these accesses can be classified as candidates for prefetching.

At process block 940, prefetching for the respective predicated load and/or predicated store instructions can be enabled when they are classified as candidates for prefetching. For example, prefetching can be enabled for an instruction block and/or for an individual instruction. As a specific example, prefetching can be enabled for an instruction block by setting a flag in the instruction header that is used to configure the processor core to enable prefetching. As another example, prefetching can be enabled for a particular instruction by using an enable bit of the instruction to encode whether prefetching is enabled for the instruction.

At process block 950, optimizations can optionally be performed within and/or between the instruction blocks. For example, instructions for determining a memory address of a load or store instruction can be moved to earlier in the instruction block so that the address is available for prefetching data from the targeted address. As a specific example, a predicated instruction for determining a memory address of a load or store instruction can be transformed to a non-predicated instruction and moved to earlier in the instruction sequence than the predicate calculation. As another example, an instruction for determining a memory address of a load or store instruction can be moved to earlier in the instruction sequence within a predicated path. As another example, a predicated load or store can be hoisted to before the predicate calculation. In other words, the predicated load or store can be transformed to a non-predicated load or store and moved to before the predicate calculation.

At process block 960, object code can be emitted for the instruction blocks targeted to be executed on the block-based processor. For example, the instruction blocks can be emitted in a format defined by the ISA of the targeted block-based processor. In particular, the instruction blocks can include an instruction block header and one or more instructions. The instruction block header can include information for determining an operating mode of the processor core. For example, the instruction block header can include an execution flag for allowing prefetching of predicated loads and stores. In one embodiment, a respective instruction block can be emitted so that the instructions of the instruction block sequentially follow the instruction header. The instructions can be emitted in a sequential order so that the instruction block can be stored in a contiguous section of memory. If the instructions are variable lengths, pad bytes can be inserted between the instructions to maintain a desired alignment, such as on word or double-word boundaries, for example. In an alternative embodiment, the instruction headers can be emitted in one stream and the instructions can be emitted in a different stream so that the instruction headers can be stored in one section of contiguous memory and the instructions can be stored in a different section of contiguous memory.

At process block 970, the emitted object code can be stored in a computer-readable memory or storage device. For example, the emitted object code can be stored into a memory of the block-based processor so that the block-based processor can execute the program. As another example, the emitted object code can be loaded onto a storage device, such as a hard-disk drive of the block-based processor so that the block-based processor can execute the program. At run-time, all or a portion of the emitted object code can be retrieved from the storage device and loaded into memory of the block-based processor so that the block-based processor can execute the program.

### X. Example Block-Based Computer Architecture

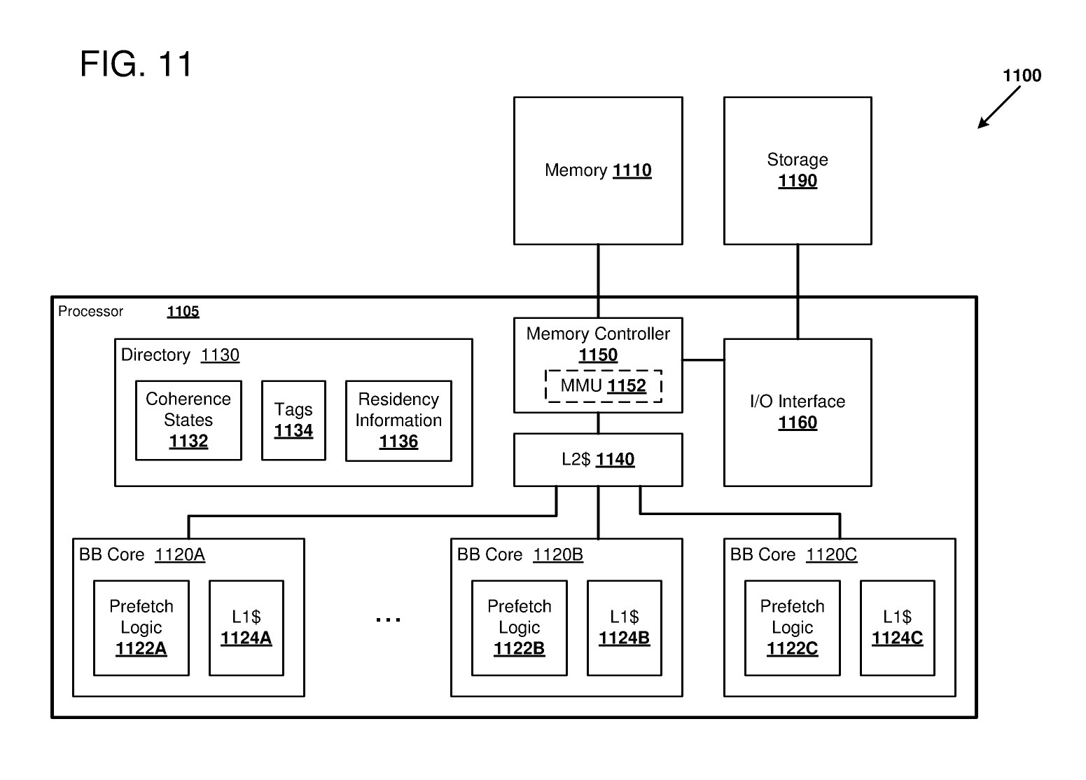

FIG. 10 is an example architecture 1000 for executing a program. For example, the program can be compiled using the method 900 of FIG. 9 to generate the instruction blocks A-E. The instruction blocks A-E can be stored in a memory 1010 that can be accessed by the processor 1005. The processor 1005 can include a plurality of block-based processor cores (including block-based processor core 1020), an optional memory controller and level-two (L2) cache 1040, cache coherence logic 1045, a control unit 1050, and an input/output (I/O) interface 1060. The block-based processor core 1020 can communicate with a memory hierarchy used for storing and retrieving instructions and data of the program. The memory hierarchy can include the memory 1010, the memory controller and level-two (L2) cache 1040, and the level-one (L1) cache 1028. The memory controller and the level-two (L2) cache 1040 can be used to generate the control signals for communicating with the memory 1010 and to provide temporary storage for information coming from or going to the memory 1010. As illustrated in FIG. 10, the memory 1010 is off-chip or external to the processor 1005. However, the memory 1010 can be fully or partially integrated within the processor 1005.

The control unit 1050 can be used for implementing all or a portion of a run-time environment for the program. The runtime environment can be used for managing the usage of the block-based processor cores and the memory 1010. For example, the memory 1010 can be partitioned into a code segment 1012 comprising the instruction blocks A-E and a data segment 1015 comprising a static section, a heap section, and a stack section. As another example, the control unit 1050 can be used for allocating processor cores to execute instruction blocks. Note that the block-based processor core 1020 includes a control unit 1030 having different functionality than the control unit 1050. The control unit 1030 includes logic for managing execution of an instruction block by the block-based processor core 1020. The optional I/O interface 1060 can be used for connecting the processor 1005 to various input devices (such as an input device 1070), various output devices (such as a display 1080), and a storage device 1090. In some examples, the control unit 1030 (and its individual components), the memory controller and L2 cache 1040, the cache coherence logic 1045, the control unit 1050, and the I/O interface 1060 are implemented at least in part using one or more of: hardwired finite state machines, programmable microcode, programmable gate arrays, or other suitable control circuits. In some examples, the cache coherence logic 1045, the control unit 1050, and the I/O interface 1060 are implemented at least in part using an external computer (e.g., an off-chip processor executing control code and communicating with the processor 1005 via a communications interface (not shown)).

All or part of the program can be executed on the processor 1005. Specifically, the control unit 1050 can allocate one or more block-based processor cores, such as the processor core 1020, to execute the program. The control unit 1050 can communicate a starting address of an instruction block to the processor core 1020 so that the instruction block can be fetched from the code segment 1012 of the memory 1010. Specifically, the processor core 1020 can issue a read request to the memory controller and L2 cache 1040 for the block of memory containing the instruction block. The memory controller and L2 cache 1040 can return the instruction block to the processor core 1020. The instruction block includes an instruction header and instructions. The instruction header can be decoded by the header decode logic 1032 to determine information about the instruction block, such as whether there are any asserted execution flags associated with the instruction block. For example, the header can encode whether data prefetching is enabled for the instruction block. During execution, the instructions of the instruction block are scheduled dynamically for execution by the instruction scheduler logic 1034, based on when the instruction operands become available. As the instructions execute, intermediate values of the instruction block (such as operand buffers of instruction windows 1022 and 1023, and registers of a load/store queue 1026) are calculated and stored locally within state of the processor core 1020. The results of the instructions are committed atomically for the instruction block. Thus, the intermediate values generated by the processor core 1020 are not visible outside of the processor core 1020 and the final results (such as writes to the memory 1010 or to a global register file (not shown)) are released as a single transaction. The processor core 1020 can include performance CSRs 1039 for monitoring performance related information during execution of one or more instruction blocks. The performance CSRs 1039 can be accessed by state access logic and the results can be logged as profile data for use by a compiler implementing profile-guided optimization.

The control unit 1030 of the block-based processor core 1020 can include logic for prefetching data associated with load and store instructions of an instruction block. The execution speed of the load and store instructions can be increased when the memory locations referenced by the load and store instructions are stored in faster levels of the memory hierarchy that are closer to the processor core 1020. Prefetching the data can include copying data associated with the load and store addresses from a slower level of the memory hierarchy into a faster level of the memory hierarchy before the instructions are executed. Thus, the time to retrieve the data can be overlapped with other instructions before the load or store instruction begins execution.

Prefetch logic 1036 can be used to generate and manage prefetch requests for data. Initially, the prefetch logic 1036 can identify one or more candidates for prefetching. For example, the prefetch logic 1036 can communicate with the header decode logic 1032 and the instruction decode logic 1033. The header decode logic 1032 can decode the instruction header to determine if data prefetching is enabled for the resident instruction block. If data prefetching is enabled, the candidates for prefetching can be identified. For example, the instruction decode logic 1033 can be used to identify load and store instructions by decoding opcodes of the instructions. The instruction decode logic 1033 can also determine whether prefetching is enabled or disabled for a particular instruction, if the particular instruction is predicated, a source of any predicate calculation, a value of a predicate result required to execute the instructions, any sources of operands for calculating an address of the data to be prefetched, and a load-store identifier of the instruction. The candidates for prefetching can be load and store instructions where prefetching is not disabled.

The prefetch logic 1036 can generate a prefetch request for a candidate for prefetching after the respective instruction is decoded and the target address of the instruction is known. The target address of the instruction can be directly encoded within the instruction or calculated from one or more operands of the instruction. For example, the operands can be encoded in the instructions as constants or immediate values, can be generated by another instruction of the instruction block, or a combination thereof. As a specific example, the target address can be the sum of an immediate value encoded in the instruction and the result from another instruction. As another example, the target address can be the sum of a first result from a first instruction and a second result from a second instruction. Wake-up and select logic 1038 can monitor the operands of the load and store instructions and notify the prefetch logic 1036 when the operands of the load and store instructions are ready. Once the operands of the load and store instructions are ready, the address can be calculated.

The prefetch logic 1036 can calculate the address for a load or store instruction in a variety of ways. For example, the prefetch logic 1036 can include a dedicated arithmetic logic unit (ALU) for calculating the address from the operands of the load or store instruction. By having a dedicated ALU within the prefetch logic 1036, the address to prefetch from can potentially be calculated as soon as the operands are ready. However, the processor 1005 can potentially be made smaller and less expensive by reusing an ALU that is part of another functional unit. The reduced size may add complexity because a shared ALU is managed so that conflicting requests are not presented to the ALU simultaneously. Additionally or alternatively, an ALU of the load-store queue can be used to calculate the target address of the load or store instruction. Additionally or alternatively, an ALU of the ALU(s) 1024 can be used to calculate the target address of the load or store instruction. The ALU(s) 1024 are used by the processor core 1020 for the execution of instructions of the instruction blocks. Specifically, during the execute stage of an instruction, the input operands are routed from operand buffers of the instruction window 1022 or 1023 to the ALU(s) 1024 and the output from the ALU(s) 1024 is written to a targeted operand buffer of the instruction window 1022 or 1023. However, one or more ALU of the ALU(s) 1024 may be idle during a given cycle which can provide an opportunity for the ALU to be used for an address calculation. The instruction scheduler logic 1034 manages the usage of the ALU(s) 1024. The prefetch logic 1036 can communicate with the instruction scheduler logic 1034 so that an individual ALU of the ALU(s) 1024 is not oversubscribed. Once the target address is calculated, a prefetch request may be issued for the instruction.

The prefetch logic 1036 can initiate a prefetch request to target addresses of load and store instructions where the target address has been determined. Memory bandwidth to the memory hierarchy may be limited and so arbitration logic of the prefetch logic 1036 can be used to determine which, if any, of the candidates for prefetching are selected. As one example, prefetch requests can be prioritized behind non-prefetch requests to the memory hierarchy. Non-prefetch requests can be from instructions that are in the execute stage and delaying the non-prefetch request behind a prefetch request may reduce the overall execution speed of the instruction block. As another example, prefetch requests for non-predicated loads and stores can be prioritized ahead of prefetch requests for predicated loads and stores. Since non-predicated loads and stores will be executed and predicated loads and stores may be speculative, the memory bandwidth may be more efficiently utilized by allowing non-predicated loads and stores to have priority over predicated loads and stores. For example, a prefetch associated with a predicated load or store can be issued before a predicate of the predicated instruction is calculated. Depending on the result of the predicate calculation, the predicated instruction may or may not be executed. If the predicated instruction is not executed, then a prefetch to the target address is wasted work.

The prefetch logic 1036 can communicate with a dependence predictor 1035 to determine which predicated instructions are more likely to be executed. Prefetch requests associated with predicated instructions more likely to be executed can be prioritized ahead of predicated instructions less likely to be executed. As one example, the dependence predictor 1035 can use a heuristic to predict a value of a predicate calculation, and thus, which predicated instructions are more likely to be executed. As another example, the dependence predictor 1035 can use information encoded in the instruction header to predict a value of a predicate calculation.

The prefetch logic 1036 can prioritize prefetches associated with predicated loads ahead of prefetches associated with predicated stores. For example, retrieving data associated with a load may have fewer side-effects than retrieving data associated with a store in a shared memory multi-processor system. Specifically, the cache coherence logic 1045 can maintain a directory and/or coherence state information for lines in the memory hierarchy. The directory information can include presence information such as where the cache line may be stored out of many processors. The coherence state information can include the state of each cache line in the hierarchy using a cache coherency protocol, such as the MESI or MOESI protocols. These protocols assign a state to lines stored in the memory hierarchy such as a modified (“M”) state, an owned (“O”) state, an exclusive (“E”) state, a shared (“S”) state, and an invalid (“I”) state. When an address of a cache line is loaded, the cache line can be assigned to the owned, exclusive, or shared state. This may cause copies of the cache line in other processors to change cache protocol states. However, when an address of a cache line is stored, the cache line will be assigned to the modified state (using a write-allocate write-back policy) which may cause the cache line to be invalidated in the caches of other processors. Thus, it may be desirable to prioritize prefetches associated with predicated loads ahead of prefetches associated with predicated stores.

The prefetch logic 1036 can initiate prefetch requests for target addresses of load and store instructions. For example, the prefetch logic 1036 can initiate a memory operation associated with the target address. The memory operation can include performing a cache coherence operation corresponding to the cache line including the memory address. For example, the cache coherence logic 1045 can be searched for coherence information related to the cache line. The memory operation can include detecting whether there is an inter-processor conflict for a cache line including the memory address. If there is no conflict, the prefetch logic 1036 can initiate a prefetch request for the target address. However, if there is a conflict, the prefetch logic 1036 can abort the prefetch request for the target address.

Prefetching the data can include copying data associated with the target address from a slower level of the memory hierarchy into a faster level of the memory hierarchy before the load instruction 540 is executed. As a specific example, a cache line including the target address can be fetched from the data segment 1014 of the memory 1010 into the L2 cache 1040 and/or the L1 cache 1028. Prefetching the data can be contrasted with executing a load instruction. For example, the data is stored in an operand buffer of the instruction window 1022 or 1023 when the load instruction is executed, but the data is not stored in the operand buffer of the instruction window 1022 or 1023 when the data is prefetched. Prefetching the data can include performing a coherence operation associated with a cache line including the target address. For example, a coherence state associated with a cache line including the target address can be updated. The coherence state can be updated within the cache coherence logic 1045 and/or within cache coherence logic of other processors sharing the memory 1010.

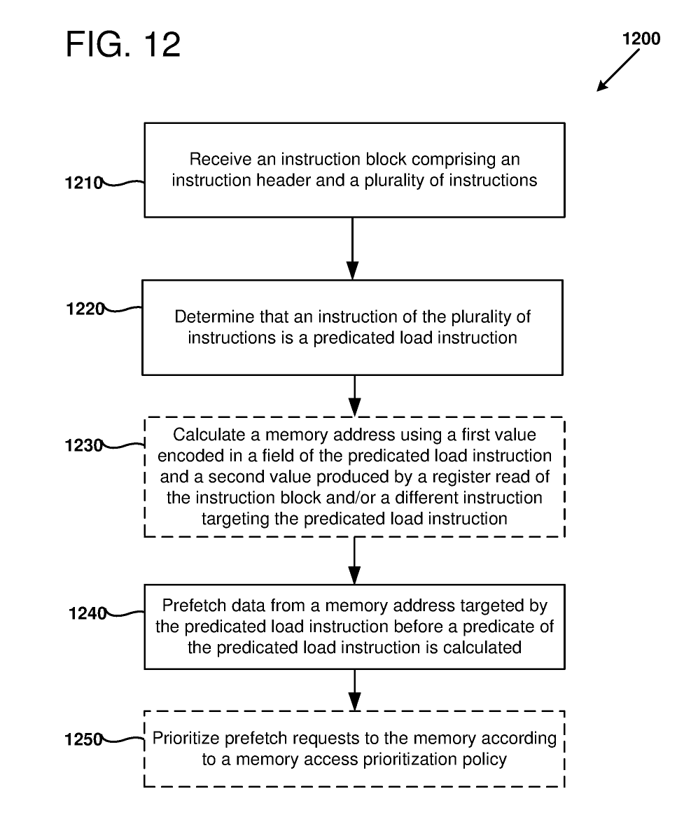

FIG. 11 illustrates an example system 1100 comprising a processor 1105 having multiple block-based processor cores 1120A-C and a memory hierarchy. The block-based processor cores 1120A-C can be physical processor cores and/or logical processor cores comprising multiple physical processor cores. The memory hierarchy can be arranged in various different ways. For example, different arrangements may include more or fewer levels within the hierarchy, and different components of the memory hierarchy can be shared among different components of the system 1100. The components of the memory hierarchy can be integrated on a single integrated circuit or chip. Alternatively, one or more of the components of the memory hierarchy can be external to a chip including the processor 1105. As illustrated, the memory hierarchy can include storage 1190, memory 1110, and an L2 cache (L2$) 1140 that is shared among the block-based processor cores 1120A-C. The memory hierarchy can include multiple L1 caches (L1$) 1124A-C that are private within a respective core of the processor cores 1120A-C. In one example, the processor cores 1120A-C may address virtual memory and there is a translation between virtual memory addresses and the physical memory addresses. For example, a memory management unit (MMU) 1152 can be used for managing and allocating virtual memory so that the addressable memory space can exceed the size of the main memory 1110. The virtual memory can be divided into pages and the active pages can be stored in the memory 1110 and inactive pages can be stored on backing store within the storage device 1190. The memory controller 1150 can communicate with the input/output (I/O) interface 1160 to move pages between main memory and the backing store.

Data can be accessed at different granularities at different levels of the memory hierarchy. For example, an instruction may access memory in units of a byte, a half-word, a word, or a double-word. The unit of transfer between the memory 1110 and the L2 cache 1140 and between the L2 cache 1140 and the L1 caches 1124A-C can be a line. A cache line can be multiple words wide, and the cache line size may differ between different levels of the memory hierarchy. The unit of transfer between the storage device 1190 and the memory 1110 can be a page or a block. A page can be multiple cache lines wide. Thus, loading or prefetching data for a load or store instruction may cause a larger unit of data to be copied from one level of the memory hierarchy to another level of the memory hierarchy. As a specific example, a load instruction executing on processor core 1120A and requesting a half-word of data that is located in a paged-out block of memory can cause a block of memory to be copied from the storage device 1190 to the main memory 1110, a first line to be copied from the main memory 1110 to the L2 cache 1140, a second line to be copied from the L2 cache 1140 to the L1 cache 1124A, and a word or half-word to be copied from the L1 cache 1124A to an operand buffer of the processor core 1120A. The requested half-word of data is contained within each of the first line, the second line, and the block.

When multiple processor cores can have different copies of a particular memory location, such as in the L1 caches 1124A-1124C, the potential exists for local copies to have different values for the same memory location. However, a directory 1130 and a cache coherence protocol can be used to keep different copies of the memory consistent. In some examples, the directory 1130 is implemented at least in part using one or more of: hardwired finite state machines, programmable microcode, programmable gate arrays, programmable processors, or other suitable control circuits. The directory 1130 can be used to maintain residency information 1136 including presence information about where copies of memory lines are located. For example, the memory lines can be located in the caches of the processor 1105 and/or in caches of other processors that share the memory 1110. Specifically, the residency information 1136 can include presence information at the granularity of the L1 caches 1124A-1124C. In order to maintain consistent copies of the memory locations, the cache coherence protocol can require that only one processor core 1120A-1120C can write to a particular memory location at a given time. Various different cache protocols can be used, such as the MESI protocol as described in this example. In order to write to the memory location, the processor core can obtain an exclusive copy of the memory location and record the coherence state as “E” in the coherence states 1132. The memory locations can be tracked at the granularity of the L1 cache line size. The tags 1134 can be used to maintain a list of all memory locations that are present in the L1 caches. Thus, each memory location has a corresponding entry in the tags 1134, the residency information 1136, and the coherence states 1132. When a processor core writes to the memory location, such as by using a store instruction, the coherence state can be changed to the modified or “M” state. Multiple processor cores can read an unmodified version of the same memory location, such as when the processor cores prefetch or load the memory location using a load instruction. When multiple copies of the memory location are stored in multiple L1 caches, the coherence state can be the shared or “S” state. However, if one of the shared copies is to be written to by a first processor, the first processor obtains an exclusive copy by invalidating the other copies of the memory location. The other copies are invalidated by having the coherence state of the other copies changed to the invalid or “I” state. Once the copy of the memory location is modified, the updated memory location can be shared by writing back the modified value to the memory and invalidating or changing the coherence state to shared for the cached copy of the memory location that was modified.

The block-based processor cores 1120A-C can execute different programs and/or threads that share the memory 1110. A thread is a unit of control within a program where instruction blocks are ordered according to a control flow of the thread. The thread can include one or more instruction blocks of the program. The thread may include a thread identifier to distinguish it from other threads, a program counter referencing a non-speculative instruction block of the thread, a logical register file for passing values between instruction blocks of the thread, and a stack for storing data, such as activation records, local to the thread. A program can be multi-threaded, where each thread can operate independently of the other threads. Thus, different threads can execute on different respective processor cores. The different programs and/or threads executing on the processor cores 1120A-C can share the memory 1110 according to a cache coherency protocol, as described above.

XI. Example Methods of Prefetching Data Associated with Predicated Loads and/or Stores

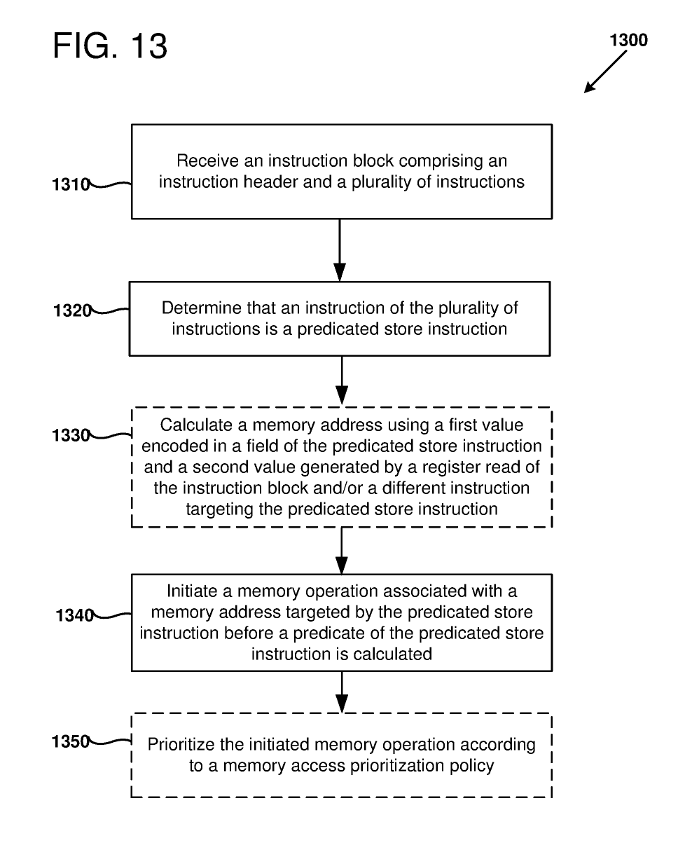

FIG. 12 is a flowchart illustrating an example method 1200 of prefetching data associated with a predicated load executing on a block-based processor core. For example, the method 1200 can be performed using the processor core 1020 when arranged in a system such as the system 1000 of FIG. 10. The block-based processor core is used to execute a program using a block-atomic execution model. The program includes one or more instruction blocks where each instruction block includes an instruction block header and a plurality of instructions. Using the block-atomic execution model, the individual instructions of the respective instruction blocks are executed and committed atomically so that final results of the instruction block are architecturally visible to other instruction blocks in a single transaction after a commit

At process block 1210, an instruction block is received. The instruction block comprises an instruction header and a plurality of instructions. For example, the instruction block can be received in response to a program counter of a processor core being loaded with a starting address of the instruction block. The plurality of the instructions can include various different types of instructions, where the different types of instructions are identified by opcodes of the respective instructions. The instructions can be predicated or non-predicated. Predicated instructions execute conditionally based on a predicate result determined at runtime of the instruction block.

At process block 1220, it can be determined that an instruction of the plurality of instructions is a predicated load instruction. For example, instruction decode logic of the processor core can identify the predicated load instruction by matching the opcode of the instruction to opcodes of load instructions. A predicate field of the instruction can be decoded to determine whether execution of the load instruction is conditioned on a predicate calculation. The instruction decode logic can identify sources of operands for the predicated load instruction, such as the source of the predicate calculation. The instruction decode logic can identify constant or immediate fields of the predicated load instruction which may be used to determine a target address of the predicated load instruction, where the target address is the location in memory of the data to load. The decoded predicated load instruction can be stored in an instruction window of the processor core.

At optional process block 1230, a memory address (e.g., the target address) can be calculated using a first value encoded in a field of the predicated load instruction and a second value produced by a register read of the instruction block and/or a different instruction directly targeting the predicated load instruction. As one example, the first value can be an immediate value of the predicated load instruction. As another example, the second value can be caused by a register read of the instruction block. Specifically, the register read can be initiated by an instruction or by decoding a field in a header of the instruction block. As another example, a different instruction can produce the second value by reading the second value from a register file or from a memory. As another example, the different instruction can produce the second value by performing a calculation such as an add or subtract operation. The first value and the second value can be used in various ways to calculate the memory address. For example, the first value and the second value can be added. As another example, one or more the first value and the second value can be sign-extended and/or shifted before the first value and the second value are added. The calculation can be performed by a dedicated functional unit (such as an ALU) in a prefetch logic block or a load-store queue. Additionally or alternatively, the calculation can be performed by an arithmetic unit of instruction execution logic datapath during an open instruction issue slot.

As another example, the memory address can be calculated using a first value produced by a first instruction targeting the predicated load instruction and a second value produced by a second instruction targeting the predicated load instruction. As another example, the memory address can be calculated using a first value encoded in a field of the predicated load instruction and a second value stored in a base register. As another example, the memory address can be calculated using a first value encoded in a field of the predicated load instruction.

At process block 1240, data from a memory address targeted by the predicated load instruction can be prefetched before a predicate of the predicated load instruction is calculated. For example, the data can be prefetched after the memory address is generated and before the predicate of the predicated load instruction is calculated. In particular, wake-up and select logic can be configured to determine when the first value associated with the predicated load instruction is ready and to initiate the prefetch logic after the first value is ready.

At optional process block 1250, prefetch requests to the memory can be prioritized according to a memory access prioritization policy. For example, the memory access prioritization policy can include best practices for maintaining efficient use of the memory bandwidth. As one example, non-prefetch requests to the memory can be prioritized ahead of the prefetch request. Non-prefetch requests may be more likely to be used than potentially speculative prefetch requests so the memory bandwidth may be more efficiently utilized. As another example, prefetch requests for predicated load instructions can be prioritized ahead of prefetch requests for predicated store instructions.

FIG. 13 is a flowchart illustrating an example method 1300 of prefetching data associated with a predicated store executing on a block-based processor core. For example, the method 1300 can be performed using the processor core 1020 when arranged in a system such as the system 1000 of FIG. 10.

At process block 1310, an instruction block is received. The instruction block comprises an instruction header and a plurality of instructions. For example, the instruction block can be received in response to a program counter of a processor core being loaded with a starting address of the instruction block. The plurality of the instructions can include various different types of instructions, where the different types of instructions are identified by opcodes of the respective instructions. The instructions can be predicated or non-predicated. Predicated instructions execute conditionally based on a predicate result determined at runtime of the instruction block.

At process block 1320, it can be determined that an instruction of the plurality of instructions is a predicated store instruction. For example, instruction decode logic of the processor core can identify the predicated store instruction by matching the opcode of the instruction to opcodes of store instructions. A predicate field of the instruction can be decoded to determine whether execution of the store instruction is conditioned on a predicate calculation. The instruction decode logic can identify sources of operands for the predicated store instruction, such as the source of the predicate calculation. The instruction decode logic can identify constant or immediate fields of the predicated store instruction which may be used to determine a target address of the predicated store instruction, where the target address is the location in memory of the data to store. The decoded predicated store instruction can be stored in an instruction window of the processor core.

At optional process block 1330, a memory address (e.g., the target address) can be calculated using a first value encoded in a field of the predicated store instruction and a second value produced by a register read of the instruction block and/or a different instruction directly targeting the predicated store instruction. As one example, the first value can be an immediate value of the predicated store instruction. As another example, the different instruction can produce the second value by reading the second value from a register file or from a memory. As another example, the different instruction can produce the second value by performing a calculation such as an add or subtract operation. The first value and the second value can be used in various ways to calculate the memory address. For example, the first value and the second value can be added. As another example, one or more the first value and the second value can be sign-extended and/or shifted before the first value and the second value are added. The calculation can be performed by a dedicated functional unit (such as an ALU) in a prefetch logic block or a load-store queue. Additionally or alternatively, the calculation can be performed by an arithmetic unit of instruction execution logic datapath during an open instruction issue slot.

As another example, the memory address can be calculated using a first value produced by a first instruction targeting the predicated store instruction and a second value produced by a second instruction targeting the predicated store instruction. As another example, the memory address can be calculated using a first value encoded in a field of the predicated store instruction and a second value stored in a base register of the processor core. As another example, the memory address can be calculated using a first value encoded in a field of the predicated store instruction.

At process block 1340, a memory operation associated with a memory address targeted by the predicated store instruction can be initiated before a predicate of the predicated store instruction is calculated. As one example, the memory operation can occur before a predicate of the predicated store instruction is calculated. In particular, the memory operation can occur after the memory address is generated and before the predicate of the predicated store instruction is calculated. Specifically, wake-up and select logic can be configured to determine when the first value associated with the predicated store instruction is ready and to initiate prefetch logic and/or cache coherence logic after the first value is ready.

Various memory operations can be performed. As one example, the memory operation can include issuing a prefetch request to a memory hierarchy of the processor for data at the calculated target address. As another example, the memory operation can include performing a cache coherence operation corresponding to a cache line including the memory address. The cache coherence operation can include fetching coherence permissions for a memory line including the calculated target address. The cache coherence operation can include determining whether an inter-thread and/or inter-processor conflict exists for a memory line including the calculated target address. Specifically, it can be determined whether the memory line is present in another processor or processor core and whether the cache coherence state of the memory line is an exclusive or shared state. If there is an inter-thread and/or inter-processor conflict a prefetch of the memory line can be aborted or an appropriate coherence action can be initiated, such as writing back a modified copy of the memory line and/or invalidating shared copies of the memory line.

At optional process block 1350, the memory operation can be prioritized according to a memory access prioritization policy. For example, the memory access prioritization policy can include rules and/or heuristics for efficiently using the memory bandwidth. As one example, the initiated memory operation can be prioritized behind prefetch requests for predicated load instructions and/or non-prefetch requests to the memory hierarchy. Generally, non-prefetch requests to the memory can be prioritized ahead of prefetch requests. As another example, prefetch requests for predicated load instructions can be prioritized ahead of prefetch requests for predicated store instructions.

### XII. Example Computing Environment

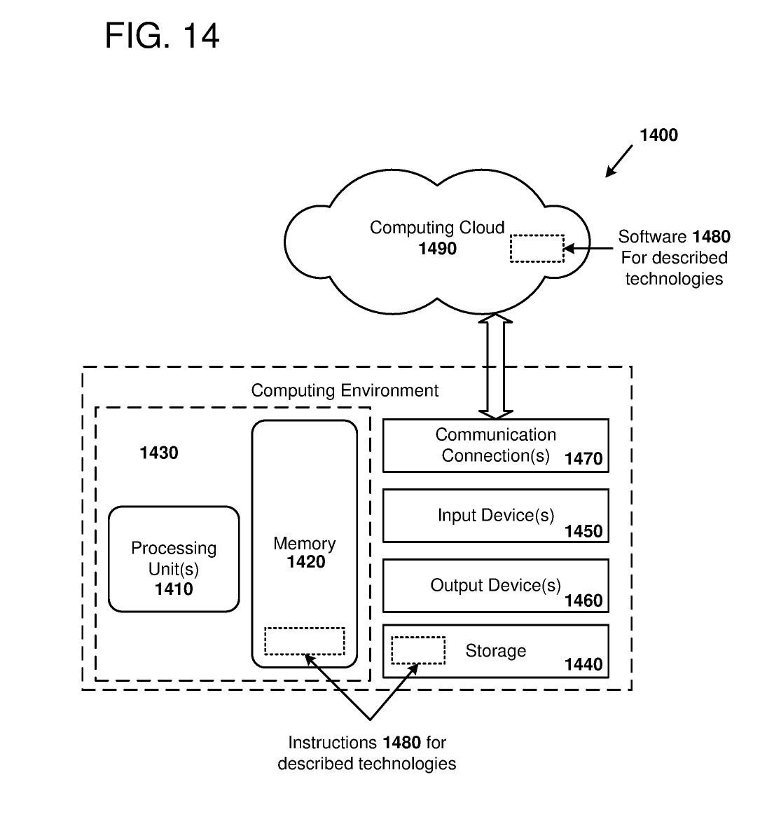

FIG. 14 illustrates a generalized example of a suitable computing environment 1400 in which described embodiments, techniques, and technologies, including supporting prefetching of data associated with predicated loads and stores of an instruction block targeted for a block-based processor, can be implemented.

The computing environment 1400 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules (including executable instructions for block-based instruction blocks) may be located in both local and remote memory storage devices.

With reference to FIG. 14, the computing environment 1400 includes at least one block-based processing unit 1410 and memory 1420. In FIG. 14, this most basic configuration 1430 is included within a dashed line. The block-based processing unit 1410 executes computer-executable instructions and may be a real or a virtual processor. In a multi-processing system, multiple processing units execute computer-executable instructions to increase processing power and as such, multiple processors can be running simultaneously. The memory 1420 may be volatile memory (e.g., registers, cache, RAM), non-volatile memory (e.g., ROM, EEPROM, flash memory, etc.), or some combination of the two. The memory 1420 stores software 1480, images, and video that can, for example, implement the technologies described herein. A computing environment may have additional features. For example, the computing environment 1400 includes storage 1440, one or more input devices 1450, one or more output devices 1460, and one or more communication connections 1470. An interconnection mechanism (not shown) such as a bus, a controller, or a network, interconnects the components of the computing environment 1400. Typically, operating system software (not shown) provides an operating environment for other software executing in the computing environment 1400, and coordinates activities of the components of the computing environment 1400.

The storage 1440 may be removable or non-removable, and includes magnetic disks, magnetic tapes or cassettes, CD-ROMs, CD-RWs, DVDs, or any other medium which can be used to store information and that can be accessed within the computing environment 1400. The storage 1440 stores instructions for the software 1480, plugin data, and messages, which can be used to implement technologies described herein.

The input device(s) 1450 may be a touch input device, such as a keyboard, keypad, mouse, touch screen display, pen, or trackball, a voice input device, a scanning device, or another device, that provides input to the computing environment 1400. For audio, the input device(s) 1450 may be a sound card or similar device that accepts audio input in analog or digital form, or a CD-ROM reader that provides audio samples to the computing environment 1400. The output device(s) 1460 may be a display, printer, speaker, CD-writer, or another device that provides output from the computing environment 1400.

The communication connection(s) 1470 enable communication over a communication medium (e.g., a connecting network) to another computing entity. The communication medium conveys information such as computer-executable instructions, compressed graphics information, video, or other data in a modulated data signal. The communication connection(s) 1470 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed agents, bridges, and agent data consumers. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1490. For example, disclosed compilers and/or block-based-processor servers are located in the computing environment 1430, or the disclosed compilers can be executed on servers located in the computing cloud 1490. In some examples, the disclosed compilers execute on traditional central processing units (e.g., RISC or CISC processors).

Computer-readable media are any available media that can be accessed within a computing environment 1400. By way of example, and not limitation, with the computing environment 1400, computer-readable media include memory 1420 and/or storage 1440. As should be readily understood, the term computer-readable storage media includes the media for data storage such as memory 1420 and storage 1440, and not transmission media such as modulated data signals.

### XIII. Additional Examples of the Disclosed Technology

Additional examples of the disclosed subject matter are discussed herein in accordance with the examples discussed above.

In one embodiment, a processor includes a block-based processor core for executing an instruction block. The instruction block includes an instruction header and a plurality of instructions. The block-based processor core includes decode logic and prefetch logic. The decode logic is configured to detect a predicated store instruction of the instruction block. The prefetch logic is in communication with the decode logic. The prefetch logic is configured to receive a first value associated with the predicated store instruction. The first value can be generated by a register read of the instruction block and/or another instruction of the instruction block that is targeting the predicated store instruction. The block-based processor core may further include wake-up and select logic in communication with the prefetch logic. The wake-up and select logic can be configured to determine when the first value associated with the predicated store instruction is ready and to initiate the prefetch logic after the first value is ready.

The prefetch logic is further configured to calculate a target address of the predicated store instruction using the received first value. The target address can be calculated in various different ways. For example, the target address can be calculated using a dedicated arithmetic unit of the prefetch logic. As another example, the target address can be calculated using an arithmetic unit of a load-store queue. As another example, calculating the target address can include performing the target address calculation during an open instruction issue slot and using an arithmetic unit of instruction execution logic.

The prefetch logic is further configured to initiate a memory operation associated with the calculated target address before a predicate of the predicated store instruction is calculated. As one example, the memory operation can be issuing a prefetch request to a memory hierarchy of the processor to prefetch a cache line spanning the calculated target address. As another example, the memory operation can be fetching coherence permissions for a memory line including the calculated target address. As another example, the memory operation can be determining whether an inter-thread conflict exists for a memory line including the calculated target address. The predicated store instruction can include a compiler hint field, and the prefetch logic may only initiate the memory operation when indicated by the compiler hint field. The initiated memory operation may be prioritized behind non-prefetch requests to the memory hierarchy. The decode logic may be further configured to detect a predicated load instruction of the instruction block, and the prefetch logic may be further configured to prioritize prefetch requests for the predicated load instruction before initiating the memory operation associated with the calculated target address.

The processor can be used in a variety of different computing systems. For example, a server computer can include non-volatile memory and/or storage devices; a network connection; memory storing one or more instruction blocks; and the processor including the block-based processor core for executing the instruction blocks. As another example, a device can include a user-interface component; non-volatile memory and/or storage devices; a cellular and/or network connection; memory storing one or more of the instruction blocks; and the processor including the block-based processor core for executing the instruction blocks. The user-interface component can include at least one or more of the following: a display, a touchscreen display, a haptic input/output device, a motion sensing input device, and/or a voice input device.

In one embodiment, a method can be used to execute a program on a processor comprising a block-based processor core. The method includes receiving an instruction block comprising a plurality of instructions. The method further includes determining that an instruction of the plurality of instructions is a predicated store instruction. The method further includes initiating a memory operation associated with a memory address targeted by the predicated store instruction before a predicate of the predicated store instruction is calculated. Initiating the memory operation may include performing a cache coherence operation corresponding to a cache line including the memory address. Additionally or alternatively, initiating the memory operation may include detecting that there is no inter-processor conflict for a cache line including the memory address. The predicated store instruction may include a prefetch enable bit and the memory operation can be initiated only when indicated by the prefetch enable bit. The method may further include prioritizing non-prefetch requests to the memory ahead of the memory operation.

The method may further include calculating the memory address using a first value encoded in a field of the predicated store instruction and a second value generated by a register read and/or a different instruction targeting the predicated store instruction. The memory address can be calculated in various different ways. For example, calculating the memory address can include using a dedicated arithmetic unit. The arithmetic unit can be dedicated within prefetch logic or a load-store queue of the block-based processor core. As another example, calculating the memory address can include requesting access to a shared arithmetic unit and using the shared arithmetic unit to calculate the memory address

In one embodiment, a method includes receiving instructions of a program and grouping the instructions into a plurality of instruction blocks targeted for execution on a block-based processor. The method further includes, for a respective instruction block of the plurality of instruction blocks: determining whether a store instruction is predicated; classifying a given predicated store instruction as a candidate for prefetching or not a candidate for prefetching; and enabling prefetching for the given predicated store instruction when it is classified as a candidate for prefetching. The method further includes emitting the plurality of instruction blocks for execution by the block-based processor. The method further includes storing the emitted plurality of instruction blocks in one or more computer-readable storage media or devices. A block-based processor can be configured to execute the stored plurality of instruction blocks generated by the method.

The given predicated store instruction can be classified in various ways. For example, classifying the given predicated store instruction can be based only on static information about the program. As a specific example, classifying the given predicated store instruction can be based on an instruction mix of the respective instruction block. As another example, classifying the given predicated store instruction can be based on dynamic information about the program.

One or more computer-readable storage media can store computer-readable instructions that, when executed by a computer, cause the computer to perform the method.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

We claim:

1. A processor comprising a block-based processor core for executing an instruction block comprising an instruction header and a plurality of instructions, the block-based processor core comprising:
decode logic configured to detect a predicated store instruction of the instruction block; and
prefetch logic configured to:
receive a first value associated with the predicated store instruction;
calculate a target address of the predicated store instruction using the received first value; and
initiate a memory operation associated with the calculated target address before a predicate of the predicated store instruction is calculated.

2. The block-based processor core of claim 1, wherein the memory operation includes issuing a prefetch request to a memory hierarchy of the processor to prefetch a cache line spanning the calculated target address.

3. The block-based processor core of claim 1, wherein the memory operation includes fetching coherence permissions for a memory line including data at the calculated target address.

4. The block-based processor core of claim 1, wherein the memory operation includes determining whether an inter-thread conflict exists for a memory line spanning the calculated target address.

5. The block-based processor core of claim 1, wherein the target address is calculated using a dedicated arithmetic unit of the prefetch logic.

6. The block-based processor core of claim 1, wherein the first value is generated by another instruction of the instruction block that targets the predicated store instruction.

7. The block-based processor core of claim 1, wherein calculating the target address comprises performing the target address calculation during an open instruction issue slot and using an arithmetic unit of instruction execution logic.

8. The block-based processor core of claim 1, wherein the predicated store instruction comprises a compiler hint field, and the prefetch logic only initiates the memory operation when indicated by the compiler hint field.

9. The block-based processor core of claim 1, wherein the initiated memory operation is prioritized behind non-prefetch requests to the memory hierarchy.

10. The block-based processor core of claim 1, further comprising:
wake-up and select logic configured to determine when the first value associated with the predicated store instruction is ready and to initiate the prefetch logic after the first value is ready.

11. A method of executing a program on a processor comprising a block-based processor core, the method comprising:
receiving an instruction block comprising a plurality of instructions;
determining that an instruction of the plurality of instructions is a predicated store instruction; and
initiating a memory operation associated with a memory address targeted by the predicated store instruction before a predicate of the predicated store instruction is calculated.

12. The method of claim 11, further comprising:
calculating the memory address using a first value encoded in a field of the predicated store instruction and a second value generated by a register read or a different instruction targeting the predicated store instruction.

13. The method of claim 11, wherein initiating the memory operation comprises performing a cache coherence operation corresponding to a cache line including the memory address.

14. The method of claim 11, wherein initiating the memory operation comprises calculating the memory address comprises using a dedicated arithmetic unit.

15. The method of claim 11, wherein the memory operation is initiated only when indicated by a prefetch enable bit of the predicated store instruction.

16. A method comprising:
receiving instructions of a program;
grouping the instructions into a plurality of instruction blocks targeted for execution on a block-based processor;
for a respective instruction block of the plurality of instruction blocks:
determine whether a store instruction is predicated;
classify a given predicated store instruction as a candidate for prefetching or not a candidate for prefetching; and
enable prefetching for the given predicated store instruction when it is classified as a candidate for prefetching;
emitting the plurality of instruction blocks for execution by the block-based processor; and
storing the emitted plurality of instruction blocks in one or more computer-readable storage media or devices.

17. The method of claim 16, wherein classifying the given predicated store instruction is based only on static information about the program.

18. The method of claim 17, wherein classifying the given predicated store instruction is based on an instruction mix of the respective instruction block.

19. The method of claim 16, wherein classifying the given predicated store instruction is based on dynamic information about the program.

20. One or more computer-readable storage media storing computer-readable instructions that when executed by a computer cause the computer to perform the method of claim 16.
